(19) United States
(12) Patent Application Publication
(10) Pub. No.: US 2024/0403616 A1
(43) Pub. Date: Dec. 5, 2024

(54) APPROXIMATING ACTIVATION FUNCTIONS IN NEURAL NETWORKS WITH PROGRAMMABLE LOOK-UP TABLE

(71) Applicant: Intel Corporation, Santa Clara, CA (US)

(72) Inventors: Umer Iftikhar Cheema, Hillsboro, OR (US); Kevin Brady, Newry (GB); Robert Simofi, Dumbravita, Timis (RO); Colm O Faolain, Dublin (IE); Deepak Abraham Mathaikutty, Chandler, AZ (US); Arnab Raha, San Jose, CA (US); Dinakar Kondru, Frisco, TX (US); Gary Baugh, Bray (IE); Darren Crews, Portland, OR (US); Fergal Connor, Dundalk (IE)

(21) Appl. No.: 18/500,229

(22) Filed: Nov. 2, 2023

(51) Int. Cl. G06N 3/048

(52) U.S. Cl. CPC G06N 3/048

(57) ABSTRACT

An activation function in a neural network may be approximated by one or more linear functions. A linear function may correspond to a segment of the input range of the activation function, e.g., a linear segment. A programmable look-up table may store slopes and intercepts of linear functions. A post processing engine (PPE) array executing the activation function may determine that an input data element of the activation function falls into the linear segment and compute an output of the linear function using the input data element. The output of the linear function may be used as the approximated output of the activation function. Alternatively, the PPE array may determine that the input data element is in a saturation segment and use a fixed value associated with the saturation segment as the approximated output of the activation function.

### TECHNICAL FIELD

This disclosure relates generally to deep neural networks (DNN), and more specifically, approximating activation functions in DNNs with programmable look-up table (LUT).

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. DNN inference also requires computation of activation functions. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 is a block diagram of a DNN system, in accordance with various embodiments.

FIG. 3 is a block diagram of a DNN module, in accordance with various embodiments.

FIGS. 4A-4D illustrate approximation of various segments in an input range of a non-linear activation function with various functions, in accordance with various embodiments.

FIG. 5 illustrates a post processing engine (PPE) array including activation function units, in accordance with various embodiments.

FIG. 6 illustrates an example activation function unit associated with compute units in accordance with various embodiments.

FIG. 7 illustrates an example configuration interface of an activation function unit, in accordance with various embodiments.

FIG. 8 illustrates an example input data element of a non-linear activation function, in accordance with various embodiments.

FIG. 9 illustrates determination of a LUT address of a linear segment including the input data element, in accordance with various embodiments.

FIG. 10 illustrates determination of a LUT address of a linear segment including another input data element, in accordance with various embodiments.

FIGS. 11A-11C illustrate mapping of BF16 exponents to LUT configuration entries, in accordance with various embodiments.

FIG. 12 illustrates a pipeline of approximating a non-linear activation function, in accordance with various embodiments.

FIG. 13 illustrates approximating an activation function with a reciprocal function, in accordance with various embodiments.

FIG. 14 illustrates approximating an activation function with an inverse square root function, in accordance with various embodiments.

FIG. 15 illustrates a pipeline for approximating the mantissa part of an output data element of an activation function, in accordance with various embodiments.

FIG. 16 illustrates an example configuration descriptor for approximating a non-linear activation function, in accordance with various embodiments.

FIG. 17 is a flowchart showing a method of approximating a non-linear activation function in a DNN, in accordance with various embodiments.

FIG. 18 is a flowchart showing a method of executing a non-linear activation function in a DNN, in accordance with various embodiments.

FIG. 19 is a flowchart showing another method of approximating a non-linear activation function in a DNN, in accordance with various embodiments.

FIG. 20 is a block diagram of an example computing device, in accordance with various embodiments.

### DETAILED DESCRIPTION

### Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

Activation functions are important parts of DNNs. An activation function can decide whether a neuron should or should not be activated by computing the weighted sum activations and adding bias. An important purpose of activation functions is to introduce non-linearity to the output of neurons. Considering the complexity of some of the non-linear activation functions used in many DNNs, hardware implementation may require approximation within certain level of accuracy.

Piece-wise linear approximation is one approach to approximate complex non-linear activation functions. Piece-wise linear is usually based on approximating complex non-linear curves using several linear segments. Each linear segment could be represented using a slope and an intercept. The complete range of a non-linear activation function may be divided into smaller regions such that each region could be approximated using a linear segment. These regions could be of variable range, but executing the linear functions, even though there can be a greater number of linear functions, can be more efficient than executing the non-linear activation function itself. The slope and intercept of linear segments can be stored in a LUT. Accuracy increase usually requires more entries in the LUT. A LUT address generation logic is usually used to generate the address of the slopes and intercepts with the LUT that correspond to the linear segment within which the input lies.

For a DNN accelerator to be versatile, flexible, and future proof, it can be important to have DNN accelerators with the capability to be programed for new activation functions as the need arises. Many currently available solutions for approximating activation functions are based on Digital Signal Processor (DSP) based kernel-based implementations. However, these currently available solutions suffer from the failure to support certain activation functions. Also, these currently available solutions lack the flexibility to support new activation functions.

Embodiments of the present disclosure provide systems and methods for approximating activation functions with programmable LUTs. A programmable architecture may be used to approximate non-linear activation functions using piece-wise linear approximation or other approximation methods (e.g., reciprocal approximation, inverse square root approximation, etc.). Compared with the DSP-based implementations of activation function approximation approaches, the programmable architecture can reduce performance and complexity overheads of computing the activation function on a DSP by computing the activation function as part of the main computing pipeline. The programmable architecture can also provide more flexibility for approximating various types of activation function and new activation functions. For instance, the programmable architecture may support activation functions including Sigmoid, Tanh, Sin, Exp (ex), Gelu, Hswish, TanhExp, Silu, Reciprocal (RCP), Inverse square root (RSQT), Squrt, Cos, ArcTan, LN, Log 2, Exponential linear unit (ELU), Swish, Mish, Hard sigmoid, error function, and so on.

In various embodiments of the present disclosure, an activation function module may identify one or more segments in an input range of an activation function in a DNN. The input range may be a complete range of the input of the activation function. The input may include input data elements in a floating-point data format, such as FP32 (where “FP” stands for floating-point), FP16, BF16 (where “BF” stands for brain floating-point), FP8, and so on. A segment may be a portion of the input range and includes some of the input data elements. A segment of the input range may also be referred to as an input segment. The activation function module may classify the identified segments. For instance, the activation function module may determine whether a segment is a linear segment, a saturation segment, and so on. A linear segment is a segment that can be approximated using a linear function, and the accuracy of the approximation can achieve a desired or target accuracy. A saturation segment is a segment that can be approximated using a fixed value (“saturation value”). The activation function module may determine configuration parameters used for configuration the approximation of the activation function. For instance, the activation function module may program a configuration descriptor. The activation function module may store intercepts and slopes of the linear segments into a LUT in the configuration descriptor and store configuration parameters of the LUT in a LUT configuration table in the configuration descriptor. The activation function module may also store saturation values and ranges of saturation segments in a saturation table in the configuration descriptor. The configuration descriptor may include other configuration parameters.

The configuration descriptor may be provided to a data processing unit (e.g., a PPE array in the data processing unit) that executes the DNN. The PPE array may compute approximated outputs of the activation function based on the configuration description. For instance, after the PPE array receives an input data element, the PPE array may identify the segment to which the input data element belongs. Compute units in the PPE array may operate in a mode in accordance with configuration parameters associated with the segment. In an example where the input data element is in a linear segment, the PPE array may determine the address of a LUT entry corresponding to the linear segment and retrieve data in the LUT entry from the LUT based on the address. The data in the LUT entry may include the slope and intercept of the corresponding linear function. A compute unit in the PPE array may then compute the output of the linear function using the input data element as an input of the linear function. The output of the linear function may be the approximated output of the activation function. In another example where the input data element is in a saturation segment, the compute units may operate in a bypass mode. The PPE array may retrieve the saturation value from the saturation table. The PPE array may output the saturation value as the approximated output of the activation function. The compute unit may be bypassed.

The approximation of activation functions with linear function and saturation functions may include approximation of sign, exponent, and mantissa parts of each output data element. An activation function may be approximated using other functions (e.g., reciprocal function or inverse square root function), in which the mantissa part of each output data element may be approximated while the exponent part may be a configuration parameter in the configuration description and may be approximated without further computation in the PPE array.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

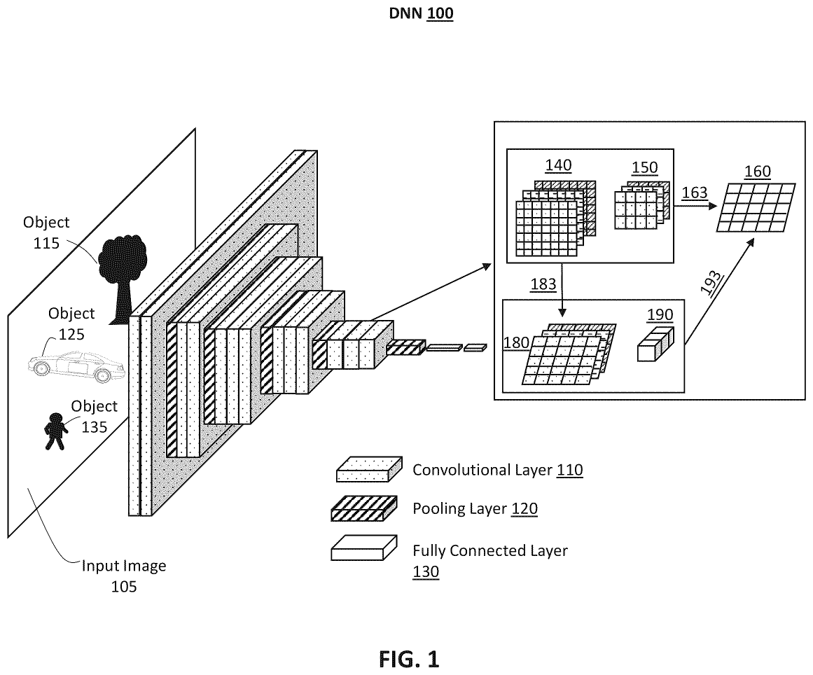

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM (input feature map) 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU, etc.) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

### Example DNN System

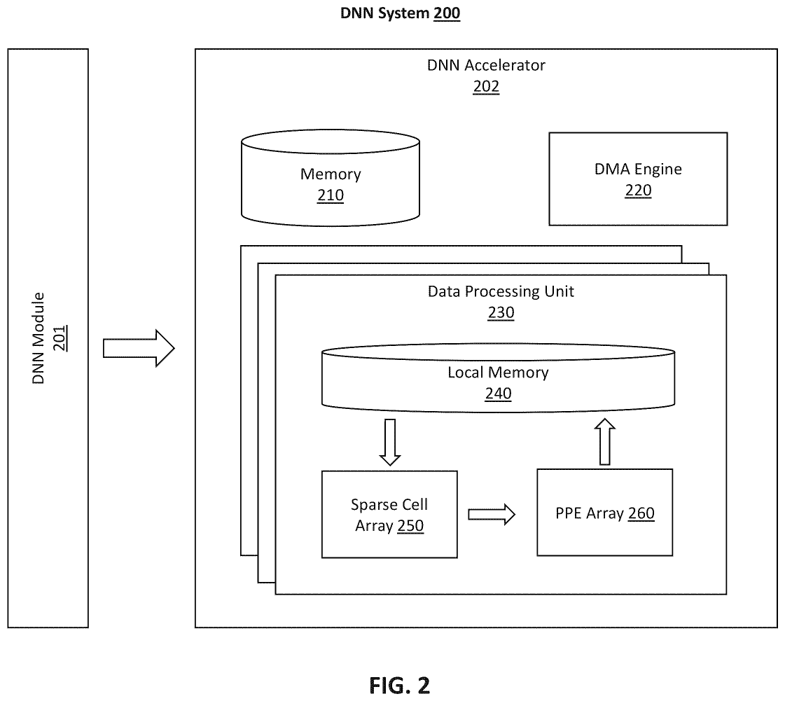

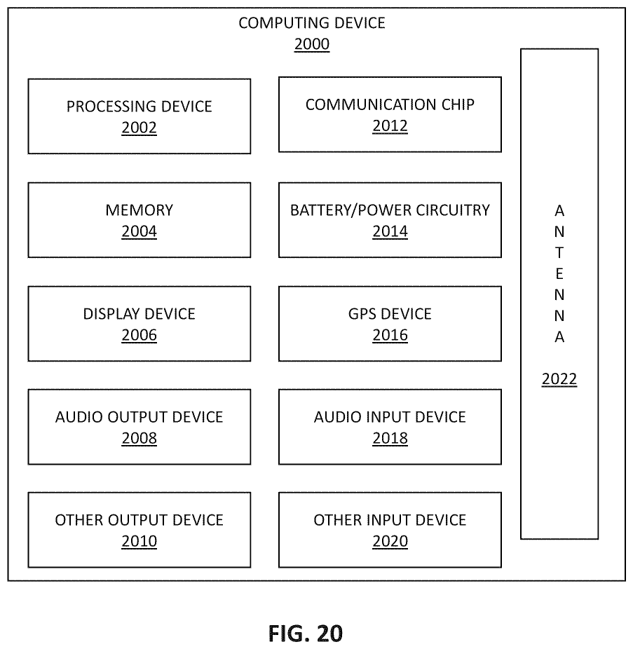

FIG. 2 is a block diagram of a DNN system 200, in accordance with various embodiments. The whole DNN system 200 or a part of the DNN system 200 may be implemented in one or more computing devices, such as the computing device 2000 in FIG. 20. The DNN system 200 can generate and execute DNNs, such as the DNN 100 in FIG. 1. As shown in FIG. 2, the DNN system 200 includes a DNN module 201 and a DNN accelerator 202. In other embodiments, alternative configurations, different or additional components may be included in the DNN system 200. For instance, the DNN system 200 may include multiple DNN modules or multiple DNN accelerators. Further, functionality attributed to a component of the DNN system 200 may be accomplished by a different component included in the DNN system 200 or a different system. In some embodiments, the DNN module 201 and DNN accelerator 202 may include different types of processing units. The DNN module 201 and DNN accelerator 202 may be implemented in the same chip or separate chips.

The DNN module 201 facilitates generation and deployment of DNNs. In some embodiments, the DNN module 201 may generate and train DNNs. For instance, the DNN module 201 can define the layered architecture of a DNN. The DNN module 201 can also determine the internal parameters of the DNN through a DNN training process. The DNN module 201 may also determine one or more hyperparameters that define how the DNN is trained. An example hyperparameter is a sparsity ratio that defines the sparsity level of one or more deep learning tensors for the DNN. The DNN module 201 may also compress DNNs, e.g., during or after training.

The DNN module 201 may deploy trained, compressed, or validated DNNs for use in deep learning applications. In some embodiments, the DNN module 201 may distribute trained, compressed, or validated DNNs to devices or systems which may use the DNNs to perform tasks (e.g., image classification, motion planning, etc.) for which the DNNs were trained. In other embodiments, the DNN module 201 may facilitate deployment of the DNNs using the DNN accelerator 202. For instance, the DNN module 201 may receive data from a device or system coupled with the DNN system 200 and input the received data (or data generated by the DNN module 201, e.g., based on the received data) into a DNN. The DNN module 201 may generate instructions (e.g., configuration files) that control the operation of the DNN accelerator 202 during the DNN execution. The DNN module 201 may receive an output of the DNN from the DNN accelerator 202. The DNN module 201 may transmit the output of the DNN (or a result of processing the output of the DNN by the DNN module 201) to the device or system.

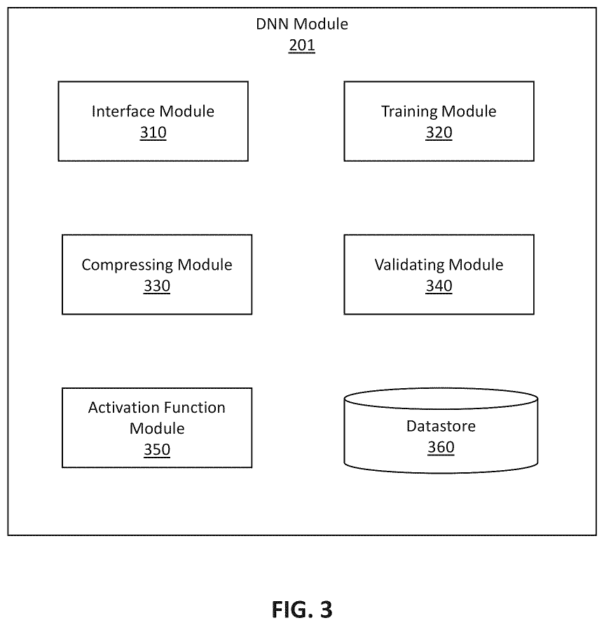

The DNN module 201 may control execution processes of trained, compressed, or validated DNNs. For instance, the DNN module 201 may facilitate approximation of non-linear activation functions with other functions including linear functions, saturation functions, reciprocal functions, inverse square root functions, other types of functions, or some combination thereof. The non-linear activation functions may be executed, e.g., by the PPE array 260, by executing these other functions. The outputs of these other functions may be used as approximated outputs of the non-linear activation functions in subsequent deep learning operations in the DNNs. The DNN module 201 may partition the input range of a non-linear activation function into multiple segments and approximate the segments with various functions. In some embodiments, the DNN module 201 may generate a configuration descriptor for a non-linear activation function. The configuration descriptor may store information to be used for approximating the non-linear activation function. For instance, the configuration descriptor may include a LUT storing slopes and intercepts of linear functions, ranges and saturation values of saturation functions, and so on. Certain aspects of the DNN module 201 are provided below in conjunction with FIG. 3.

The DNN accelerator 202 executes DNNs provided by the DNN module 201. For instance, the DNN accelerator 202 can perform DNN execution, e.g., by running deep learning operations in the DNNs, for training DNNs or for using the trained/compressed/validated DNNs to perform tasks. As shown in FIG. 2, the DNN accelerator 202 includes a memory 210, a DMA (direct memory access) engine 220, and data processing units 230 (individually referred to as “data processing unit 230”). In other embodiments, alternative configurations, different or additional components may be included in the DNN accelerator 202. For example, the DNN accelerator 202 may include more than one memory 210 or DMA engine 220. As another example, the DNN accelerator 202 may include a single data processing unit 230. Further, functionality attributed to a component of the DNN accelerator 202 may be accomplished by a different component included in the DNN accelerator 202 or by a different system. A component of the DNN accelerator 202 may be implemented in hardware, software, firmware, or some combination thereof.

The memory 210 stores data associated with deep learning operations performed by the DNN accelerator. In some embodiments, the memory 210 may store data to be used by the data processing units 230 for DNN execution. For example, the memory 210 may store weights, such as weights of convolutional layers, which are determined by training DNNs. As another example, the memory 210 may store inputs to DNNs or outputs of DNNs. The memory 210 may also store data generated by the data processing units 230 from performing deep learning operations in DNNs. Example deep learning operations include convolutions (also referred to as “convolutional operations”), pooling operations, elementwise operations, activation functions, other types of deep learning operations, or some combination thereof. The memory 210 may be a main memory of the DNN accelerator 202. In some embodiments, the memory 210 includes one or more dynamic random-access memories (DRAMs).

The DMA engine 220 facilitates data transfer between the memory 210 and local memories of the data processing units 230. For example, the DMA engine 220 can read data from the memory 210 and write data into a local memory of a data processing unit 230. As another example, the DMA engine 220 can read data from a local memory of a data processing unit 230 and write data into the memory 210. The DMA engine 220 provides a DMA feature that allows the data processing unit 230 to initiate data transfer between the memory 210 and the local memories of the data processing units 230 and to perform other operations while the data transfer is in being conducted. In some embodiments, the DMA engine 220 may read tensors from the memory 210, modify the tensors in a way that is optimized for the data processing unit 230 before it writes the tensors into the local memories of the data processing units 230.

The data processing units 230 can perform deep learning operations in DNNs. For instance, a data processing unit 230 may run a deep learning operation in a DNN layer, or a portion of the deep learning operation, at a time. The data processing units 230 may be capable of running various types of deep learning operations, such as activation functions, convolution, pooling, elementwise operation, linear operation, non-linear operation, and so on. In an example, a data processing unit 230 may perform convolutions, e.g., standard convolution or depthwise convolution. In some embodiments, the data processing unit 230 receives an input tensor and one or more convolutional kernels and performs a convolution with the input tensor and convolutional kernels. The result of the convolution may be an output tensor, which can be further computed, e.g., by the data processing unit 230 or another data processing unit 230. In some embodiments, the operations of the DNN layers may be run by multiple data processing units 230 in parallel. For instance, multiple data processing units 230 may each perform a portion of a workload for a convolution. Data may be shared between the data processing units 230. A data processing unit 230 may also be referred to as a compute tile. In some embodiments, each data processing unit 230 may be a processing unit.

In the embodiments of FIG. 2, each data processing unit 230 includes a local memory 240, a sparse cell array 250, and a PPE array 260. Some or all the components of the data processing unit 230 can be implemented on the same chip. In other embodiments, alternative configurations, different or additional components may be included in the data processing unit 230. For instance, the data processing unit 230 may include an additional module for loading data into the sparse cell array 250 from the local memory 240 or an additional module for draining data from the PPE array 260 into the local memory 240. Further, functionality attributed to a component of the data processing unit 230 may be accomplished by a different component included in the data processing unit 230, a different data processing unit 230, another component of the DNN accelerator 202, or a different system. A component of the data processing unit 230 may be implemented in hardware, software, firmware, or some combination thereof. Data processing units may also be referred to as compute blocks.

The local memory 240 is local to the corresponding data processing unit 230. In the embodiments of FIG. 2, the local memory 240 is inside the data processing unit 230. In other embodiments, the local memory 240 may be outside the data processing unit 230. Data in the local memory 240 may be transferred to or from the memory 210, e.g., through the DMA engine 220. In some embodiments, data in the local memory 240 may be transferred to or from the local memory of another data processing unit 230. The local memory 240 may store data received, used, or generated by the sparse cell array 250 and the PPE array 260. Examples of the data may include input activations, weights, output activations, sparsity bitmaps, and so on.

In some embodiments, the local memory 240 includes one or more static random-access memories (SRAMs). The local memory 240 may be byte-addressable, and each memory address identifies a single byte (eight bits) of storage. In some embodiments, the local memory 240 may include memory banks. The number of data banks in the local memory 240 may be 16, 64, 128, 256, 512, 1024, 2048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 240 in a single read cycle. In other embodiments, 16 bits can be transferred from the local memory 240 in multiple read cycles, such as two cycles.

The sparse cell array 250 may include sparse cells arranged in columns, or columns and rows. Each sparse cell may include an array of MAC units that can perform MAC operations. In some embodiments (e.g., embodiments where the data processing unit 230 executes a convolutional layer), a computation in an MAC unit may be an MAC operation on an activation operand and a weight operand. The activation operand is an activation tensor that may include one or more activations in the input tensor of the convolution. Different activations may be in different input channels. The weight operand is a weight tensor that may include one or more weights in the filter of the convolution. The values of the weights are determined through training the DNN. The weights in the weight operand may be in different input channels.

In some embodiments, an MAC unit includes one or more multipliers for performing multiplications. An MAC unit may also include one or more accumulators (“adders”) for performing accumulations. A column of MAC units is referred to as an MAC column. An MAC column may be associated with one or more MAC lanes. An MAC lane is a path for loading data into an MAC column. An MAC lane may be also referred to as a data transmission lane or data loading lane. An MAC column may have multiple MAC lanes. The loading bandwidth of the MAC column is an aggregation of the loading bandwidths of all the MAC lanes associated with the MAC column. With a certain number of MAC lanes, data can be fed into the same number of independent MAC units simultaneously. In some embodiments where an MAC column has four MAC lanes for feeding activations or weights into the MAC column and each MAC lane may have a bandwidth of 16 bytes, the four MAC lanes can have a total loading bandwidth of 64 bytes.

In some embodiments, the sparse cell array 250 may be capable of depthwise convolution, standard convolution, or both. In a depthwise convolution, an MAC unit may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the MAC unit. The sparse cell array 250 may output multiple output operands at a time, each of which is generated by a different MAC unit. In a standard convolution, MAC operations may include accumulations across the channels. For instance, as opposed to generating an output operand, a MAC unit may accumulate products across different channels to generate a single output point.

In some embodiments, the sparse cell array 250 may include sparsity acceleration logic for facilitating sparsity acceleration. For instance, each sparse cell in the sparse cell array 250 may include one or more sparsity modules. In an example, each MAC column or each MAC row may have a corresponding sparsity module that accelerates MAC operations in the MAC column or MAC row. In some embodiments, a sparsity module accelerates computations in the sparse cell array 250 based on sparsity in activations or sparsity in weights. The sparsity module may include a storage unit that stores a sparsity tensor. The sparsity tensor may be an activation sparsity tensor, a weight sparsity tensor, or a combination of both.

The sparsity module may use the sparsity tensor to identify which data elements of the dense tensor correspond to data elements of the sparse tensor. Each identified data element of the dense tensor and the corresponding data element of the sparse tensor may constitute an activation-weight pair for an MAC operation. For instance, the identified data element of the dense tensor will be multiplied with the corresponding data element of the sparse tensor in the MAC operation. The sparsity module may select one or more data elements of the dense tensor based on one or more sparsity elements of the sparsity tensor that correspond to one or more nonzero valued data elements of the dense format of the sparse tensor. The sparsity module can forward the identified activation-weight pairs to the MAC units. Other data elements of the dense tensor would be skipped and not computed by the MAC units to accelerate computation in the sparse cell array 250, as these data elements will not contribute to the result of the MAC operation.

The PPE array 270 processes outputs of the sparse cell array 250. In some embodiments, the PPE array 260 executes activation functions, including non-linear activation functions. The PPE array 260 may receive outputs of the sparse cell array 250 as inputs to the activation functions. An input to an activation function may be a tensor including a plurality of input data elements. The tensor may be an output tensor of a DNN layer. In some embodiments, an input to an activation function may be in a range, which is the input range of the activation function. The PPE array 270 may compute outputs of non-linear activation functions by using linear functions that approximate the non-linear activation functions. For instance, in the execution of a non-linear activation function, the PPE array 270 may apply a linear function on some or all input data elements and use the outputs of the linear function as the outputs of the non-linear activation function. To apply the linear function on input data elements, the PPE array 270 may use data stored in a programmable LUT. The programmable LUT may be included in the PPE array 270. The data stored in the programmable LUT may be determined by the DNN module 201. In some embodiments, the PPE array 270 may output a predetermined value as outputs of a non-linear activation function for some input data elements. The predetermined value may be stored in a saturation table in the PPE array 270.

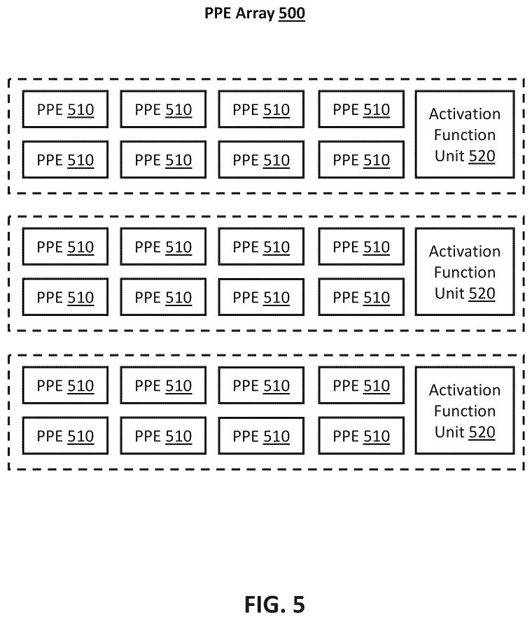

In some embodiments, the PPE array 260 may transmit the outputs of the activation functions to the local memory 240. The outputs of the activation functions may be retrieved later by the sparse cell array 250 from the local memory 240 for further computation. For instance, the PPE array 260 may receive an output tensor of a DNN layer from the sparse cell array 250 and computes one or more activation functions on the output tensor. The results of the computation by the PPE array 260 may be stored in the local memory 240 and later used as input tensor of the next DNN layer. In addition or alternative to activation functions, the PPE array 260 may perform other types of post processing on outputs of the sparse cell array 250. For instance, the PPE array 260 may apply a bias on an output of the sparse cell array 250. Certain aspects of the PPE array 260 are described below in conjunction with FIG. 5.

FIG. 3 is a block diagram of a DNN module 300, in accordance with various embodiments. The DNN module 300 may be an embodiment of the DNN module 201 in FIG. 2. As shown in FIG. 3, the DNN module 300 includes an interface module 310, a training module 320, a compressing module 330, a validating module 340, an activation function module 350, and a datastore 360. In other embodiments, alternative configurations, different or additional components may be included in the DNN module 300. Further, functionality attributed to a component of the DNN module 300 may be accomplished by a different component included in the DNN module 300 or a different module or system.

The interface module 310 facilitates communications of the DNN module 300 with other modules or systems. For example, the interface module 310 establishes communications between the DNN module 300 with an external database to receive data that can be used to train DNNs or input into DNNs to perform tasks. As another example, the interface module 310 supports the DNN module 300 to distribute DNNs to other systems, e.g., computing devices configured to apply DNNs to perform tasks.

The training module 320 trains DNNs by using a training dataset. The training module 320 forms the training dataset. In an embodiment where the training module 320 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validating module 340 to validate performance of a trained DNN. The portion of the training dataset not including the tuning subset and the validation subset may be used to train the DNN.

The training module 320 also determines hyperparameters for training the DNN.

Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 5, 10, 50, 100, 500, 1000, or even larger.

The training module 320 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, SoftMax or logistic layers, and so on. The convolutional layers of the DNN abstract the input image to a feature map that is represented by a tensor specifying the feature map height, the feature map width, and the feature map channels (e.g., red, green, blue images include 2 channels). A pooling layer is used to reduce the spatial volume of input image after convolution. It is used between two convolution layers. A fully connected layer involves weights, biases, and neurons. It connects neurons in one layer to neurons in another layer. It is used to classify images between different categories by training.

In the process of defining the architecture of the DNN, the training module 320 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 320 defines the architecture of the DNN, the training module 320 inputs a training dataset into the DNN. The training dataset includes a plurality of training samples. An example of a training sample includes an object in an image and a ground-truth label of the object. The training module 320 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 320 uses a cost function to minimize the error.

The training module 320 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 320 finishes the predetermined number of epochs, the training module 320 may stop updating the parameters in the DNN. The DNN having the updated parameters is referred to as a trained DNN.

The compressing module 330 compresses DNNs. For instance, the compressing module 330 may add pruning operations to DNN layers to reduce computational complexity or memory usage. A pruning operation may prune weight tensors of a DNN layer by changing one or more nonzero valued weights of the layer to zeros. The modification may be done before, during, or after training. Weights may be pruned during training, during inference, or a combination of both. The compressing module 330 may determine a sparsity ratio for a DNN layer. The sparsity ratio may be a ratio of the number of zero-valued weight to the total number of weights in the layer. The compressing module 330 may perform the pruning operation till the sparsity ratio of the DNN layer meets a target sparsity ration, such as 10%, 20%, 20%, 30%, 50%, and so on.

In some embodiments, the compressing module 330 may select one or more layers in a DNN and modify each selected layer with a pruning operation. For instance, the compressing module 330 may select computationally complex layers, such as layers with large filters. For a pruning operation of a layer or of a type of layer, the compressing module 330 may determine a weight threshold that would not cause a loss of the accuracy of the DNN to exceed an accuracy loss constraint. A pruning operation may modify weights having absolute values above the weight threshold to zeros and leave the other weights unchanged. The weight pruning can reduce memory storage as zero-valued weights may not be stored. Also, the number of operations in the layer can be reduced as computations on zero-valued weights can be skipped without impacting the output of the layer. In some embodiments, the compressing module 330 may also measure energy saving, final DNN accuracy, or layer-wise sparsity caused by pruning operations.

After compressing a DNN, the compressing module 330 may fine tune the DNN, e.g., through a retraining process. The compressing module 330 may fine tunes DNNs after weights are pruned. In some embodiments, the fine-tuning process is a retraining or further training process. For instance, after weights in a DNN are pruned, the compressing module 330 may further train the DNN by inputting a training dataset into the DNN. The values of the unpruned weights in the DNN may be modified based on outputs of the DNN and ground-truth labels of the training samples in the training dataset. In some embodiments, the values of the pruned weights (i.e., zero) are not changed during the fine-tuning process. For instance, the compressing module 330 may place a mask over a pruned weight block and the mask can prevent values in the pruned weight blocks from being changed during the fine-tuning process. In other embodiments, the values of all weights, including the pruned weights, may be changed during the fine-tuning process. After one or more cycles of retraining and weight changing by the compressing module 330, the compressing module 330 may perform a new pruning process, e.g., by selecting weight blocks and pruning the selected weight blocks. In some embodiments, the weight pruning process may be repeated multiple times before the fine-tuning process is done.

In some embodiments, the number of epochs in the fine-tuning process may be different from the number of epochs in the training process in which the pre-pruning values of the weights are determined. For instance, the fine-tuning process may have less epochs than the training process. In an example, the number of epochs in the fine-tuning process may be relatively small, such as 2, 2, 3, 5, and so on.

The validating module 340 verifies accuracy of trained or compressed DNNs. In some embodiments, the validating module 340 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 340 may determine an accuracy score measuring the precision, recall, or a combination of precision and recall of the DNN. The validating module 340 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validating module 340 may compare the accuracy score with a threshold score. In an example where the validating module 340 determines that the accuracy score of the augmented model is less than the threshold score, the validating module 340 instructs the training module 320 to re-train the DNN. In one embodiment, the training module 320 may iteratively re-train the DNN until the occurrence of a stopping condition, such as the accuracy measurement indication that the DNN may be sufficiently accurate, or a number of training rounds having taken place.

The activation function module 350 programs configuration descriptors for approximating non-linear activation functions in DNNs. In some embodiments, the activation function module 350 may identify one or more segments in the input range of a non-linear activation function. The input range may be a range that includes some or all possible values of inputs into the non-linear activation function. The input range may depend on the data formats of the inputs. The activation function module 350 may support various data formats, including floating-point formats, such as FP32, FP16, BF16, FP8, and so on. The activation function module 350 may determine functions to be used to approximate each of the identified segments. For each determined function, the activation function module 350 may determine configuration parameters, which may include data to be used to execute the determined function. The activation function module 350 may generate a configuration descriptor that includes the configuration parameters of all the determined functions. The configuration descriptor may be provided to a PPE array (e.g., the PPE array 260) to approximate the non-linear activation function with the determined functions.

Examples of functions for approximating non-linear activation functions may include linear function, saturation function, reciprocal function, inverse square root function, and so on. A linear function may be denoted as y=ax+b, where a denotes the slope of the linear function, b denotes the intercept of the linear function, x denotes the input of the linear function, and y denotes the output of the linear function. A saturation function may be denoted as y=c, x∈(a, b), where c denotes a saturation value that is a fixed value (e.g., a constant), x denotes the input of the saturation function that falls into a range from a minimum value a to a maximum value b, and y denotes the output of the saturation function.

In some embodiments, the activation function module 350 may facilitate programmable piece-wise linear approximation of non-linear activation functions. The activation function module 350 may identify one or more linear segments in the input range. For instance, the activation function module 350 may identify a segment in the input range, e.g., by selecting an exponent in the input range. The segment includes data elements having the selected exponent. The activation function module 350 may determine a linear function for the segment and evaluate an accuracy of the linear function. The activation function module 350 may measure the accuracy of the linear function by comparing outputs of the linear function with real outputs of the non-linear activation function for inputs falling into the segment. The activation function module 350 may determine whether the accuracy of the linear function meets a desired accuracy, e.g., whether the accuracy is no less than the desired accuracy. In embodiments where the accuracy meets the desired accuracy, the activation function module 350 may store parameters of the linear function (e.g., slope and intercept) into a LUT. In embodiments where the accuracy does not meet the desired accuracy, the activation function module 350 may divide the segment into multiple smaller segments and determine whether any of the smaller segment is a linear segment. The activation function module 350 may store the parameters of all identified linear segments into the LUT.

In addition to the LUT, the activation function module 350 may also generate LUT configuration parameters, which may be stored in a LUT configuration table (“LUT_CFG”). The LUT configuration parameters may be used to search for intercepts and slopes of linear segments in the LUT. For instance, the LUT configuration parameters may include information indicating addresses of entries in the LUT. Each entry may encode the intercept and slope of a linear segment. The LTU configuration parameters may be used to determine addresses of the entries for the linear functions that are to be used for approximating the non-linear activation function.

In some embodiments, the activation function module 350 may also determine whether a segment of the input range is a saturation segment. For instance, the activation function module 350 may determine whether outputs of the non-linear activation function may be approximated by a fixed value within a segment of the input range. In embodiments where the activation function module 350 determines that outputs of the non-linear activation function may be approximated by a single value within the segment, the activation function module 350 may classify the segment as a saturation segment. The activation function module 350 may compute parameters of the saturation segment (e.g., the saturation value, the minimum value of the segment, the maximum value of the segment, etc.) in a saturation table. The saturation table may also store one or more values for one or more other saturation segments.

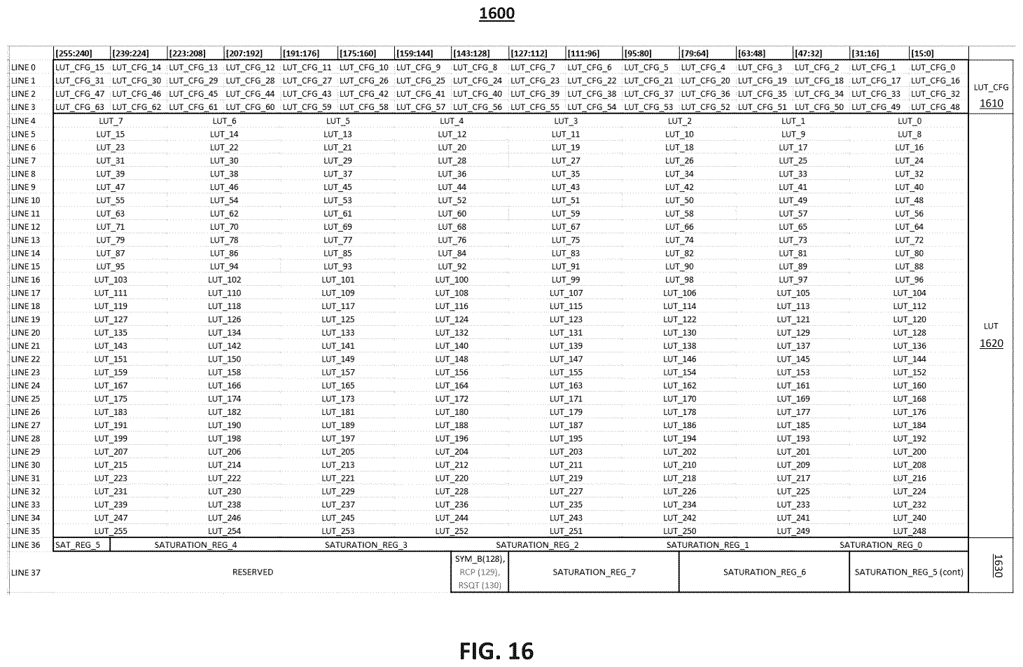

In embodiments where the activation function module 350 determines to use other functions to approximate a non-linear activation function, the activation function module 350 may generate other configuration parameters. In some embodiments, the activation function module 350 generates a configuration description for each to-be-approximated non-linear activation function. The configuration descriptor may include all the configuration parameters determined by the activation function module 350 for the non-linear activation function. An example of configuration descriptors generated by the activation function module 350 is the configuration descriptor 1600 in FIG. 16.

The datastore 360 stores data received, generated, used, or otherwise associated with the DNN module 300. For example, the datastore 360 stores the datasets used by the training module 320 and validating module 340. The datastore 360 may also store data generated by the training module 320 and validating module 340, such as the hyperparameters for training DNNs, internal parameters of trained DNNs (e.g., weights, etc.), data for sparsity acceleration (e.g., sparsity bitmap, etc.), and so on. The datastore 360 may store configuration parameters generated by the activation function module 350. In the embodiment of FIG. 3, the datastore 360 is a component of the DNN module 300. In other embodiments, the datastore 360 may be external to the DNN module 300 and communicate with the DNN module 300 through a network.

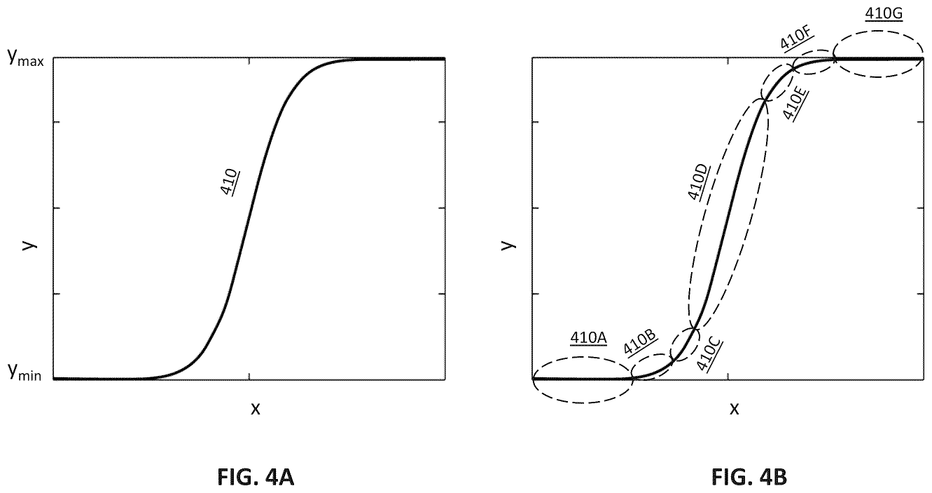

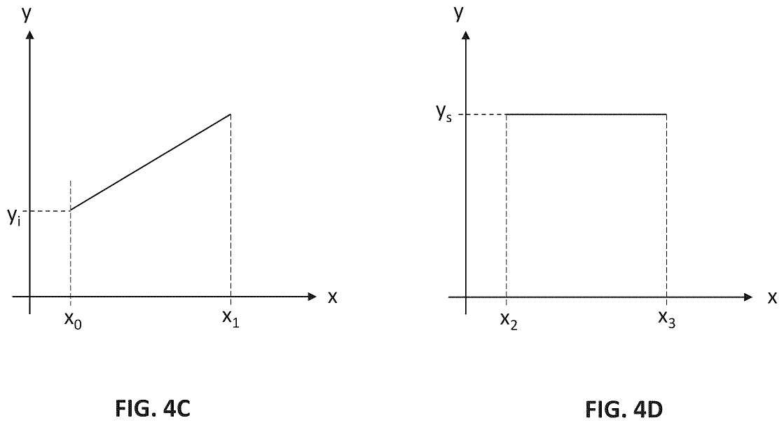

FIGS. 4A-4D illustrate approximation of various segments in an input range of a non-linear activation function with various functions, in accordance with various embodiments. FIG. 4A shows a curve 410 that represents the non-linear activation function. The curve 410 is in an x-y coordinate system, where x denotes input to the non-linear activation function and y denotes output of the non-linear activation function. The range of x coordinates of data points on the curve 410 may be the input range of the non-linear activation function. The output range of the non-linear activation function is from a minimum value (yₘᵢₙ) to (yₘₐₓ). In FIG. 4B, the curve 410 is partitioned into segments 410A-410G. Each of the segments 410A-410G corresponds to a different portion of the input range. The segments 410A-410G may be approximated by different functions.

In some embodiments, PWL approximation may be used for each of the segments 410B-410F. The segments 410B-410F may be classified as linear segments. The non-linear activation function in each of the segments 410B-410F may be approximated by a linear function. An example linear segment is illustrated in FIG. 4C. The linear segment corresponds to a range from x₀ to x₁. x₀ may denote the start of the linear segment (e.g., the minimum value in the linear segment), and x₁ may denote the end of the linear segment. The linear function of the linear segment in FIG. 4C may be denoted as:

$$y = s ( x - {x}_{0} ) + {y}_{i}$$

Where y denotes the output of the linear function, s denotes the slope (also referred to as “multiplier”) of the linear function, x denotes the input of the linear function, and yi denotes the intercept (also referred to as “offset”) of the linear function. The linear functions for the segments 410B-410F may have different slopes, intercepts, or offset values. The slopes and intercepts are programmable and can be stored in a LUT table.

In some embodiments, the segments 410A and 410G may be classified as saturation segments. For all input data elements falling into the segment 410A, the outputs of the non-linear activation function in the segment 410A may be approximated by a fixed value, such as yₘᵢₙ, despite differences in the input data elements. For all input data elements falling into the segment 410G, the outputs of the non-linear activation function in the segment 410A may be approximated by another fixed value, such as yₘₐₓ. The two fixed values may be computed by the activation function module 350 and stored in a saturation table. In some embodiments, the segments 410A and 410G are also referred to as linear segments for which the linear functions have zero-valued slopes.

FIG. 5 illustrates a PPE array 500 including activation function units 520, in accordance with various embodiments. The activation function units 520 are individually referred to as “activation function unit 520.” The activation function units 510 may function as the configuration logic of the PPE array 500. The PPE array 500 also includes PPEs 510, which are individually referred to as “PPE 510.” The PPEs 510 may be on one or more compute data paths of the PPE array 500. In other embodiments, alternative configurations, different or additional components may be included in the PPE array 500. For instance, the PPE array 500 may include a different number of PPEs 510 or activation function units 520. Further, functionality attributed to a component of the PPE array 500 may be accomplished by a different component included in the PPE array 500 or a different module, device, or system. The PPE array 500 may be an example of the PPE array 260 in FIG. 2.

Each PPE 510 may receive input data and compute output data to be used as outputs of activation functions. The output data may be approximated outputs of non-linear activation functions. In some embodiments, a PPE may include one or more compute units and one or more register files. A compute unit may be configured to execute linear functions, including linear functions used to approximate non-linear activation functions. A compute unit may include one or more multipliers and one or more accumulators. A register file in a PPE 510 may be used to store data input into the PPE 510, such as input data elements of non-linear activation functions, slopes and intercepts of linear functions approximating the non-linear activation functions, and so on. The register file or a separate register file in the PPE 510 may store data computed by the PPE 510, which may be output data elements of non-linear activation function.

The activation function units 520 configure operations of the PPEs 510 for executing activation functions. In some embodiments, an activation function unit 520 may configure the operations of one or more PPEs 510 associated with the activation function unit 520. In the embodiments of FIG. 5, each activation function unit 520 is associated with eight PPEs 510 in FIG. 5. In other embodiments, an activation function unit 520 may be associated with a different number of PPEs 510. An activation function unit 520 may determine the operation mode of a PPE 510. For instance, the activation function unit 520 may trigger the PPE 510 to operate in a linear function mode or in a bypass mode. The activation function unit 520 may determine the operation mode of the PPE 510 based on an input data element received by the activation function unit 520.

In embodiment where the activation function unit 520 selects the linear function mode, the activation function unit 520 may provide data needed by the PPE 510 to execute a linear function, such as the input data element, an increment value of the input data element, the slope of the linear function, the intercept of the linear function, other data, or some combination thereof. In embodiment where the activation function unit 520 selects the bypass mode, the activation function unit 520 may provide a fixed value to the PPEs 510 and cause the PPEs 510 to output the fixed value as output data elements of the activation function.

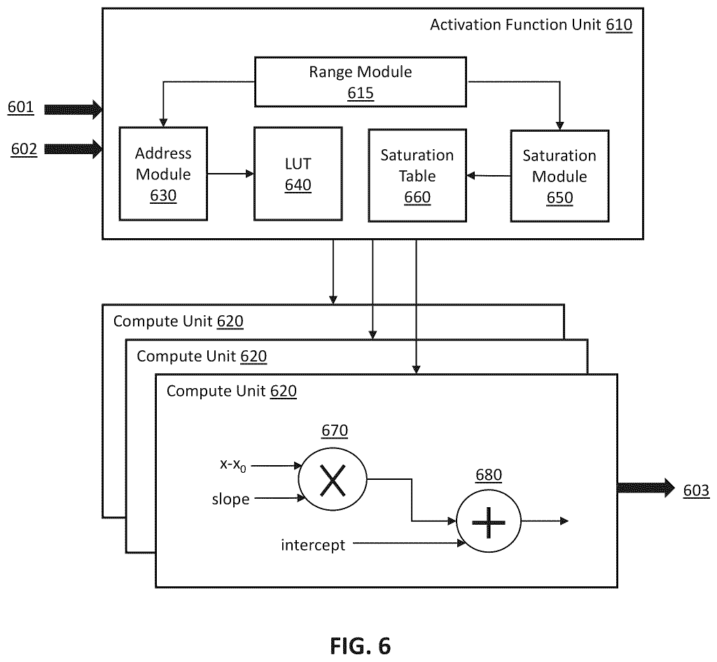

FIG. 6 illustrates an example activation function unit 610 associated with compute units 620, in accordance with various embodiments. The activation function unit 600 may be an example of the activation function unit 520 in FIG. 5. The compute units 620 are individually referred to as “compute unit 610.” The compute units 620 may be compute units of one or more PPEs, such as the PPEs 510 in FIG. 5. Even though the activation function unit 610 is associated with three compute units 620, the activation function unit 610 may be associated with a different number of compute units 620 or even a single compute unit 620.

The activation function unit 610 controls operations of the computer units 620 for computing output data elements of activation functions. As shown in FIG. 6, the activation function unit 610 includes a range module 615, an address module 630, a LUT 640, a saturation module 650, and a saturation table 660. In other embodiments, alternative configurations, different or additional components may be included in the activation function unit 610. Further, functionality attributed to a component of the activation function unit 610 may be accomplished by a different component included in the activation function unit 610 or a different module, device, or system.

In the embodiments of FIG. 6, the activation function unit 610 receives a configuration signal 601 and a data signal 602. The configuration signal 601 may be received through a configuration bus. The configuration signal 601 may include one or more configuration parameters, which may be provided by the DNN module 201. The configuration signal 601 may be sent to the activation function unit 600 through a configuration bus. The configuration signal 601 may program multiple activation function units (e.g., some or even all activation function units in a PPE array) in parallel.

The data signal 602 may be received through a data port, such as a data input port. The data signal 602 may include one or more input data elements of the activation function. In some embodiments, the configuration signal 601 may trigger one or more operation cycles of the activation function unit 610 and the compute units 620 for computing approximated outputs of the non-linear activation function using input data elements in the data signal 602.

In an example operation cycle for processing an input data element in the data signal 602, the range module 615 in the activation function unit 610 may determine which segment of the non-linear activation function the input data element falls into. For instance, the range module 615 may compare the input data element with the minimum value or maximum value of a segment. The range module 615 may determine that the input data element falls into the segment based on a determination that the input data element is no greater than the maximum value or no lower than the minimum value. The segment may be a linear segment or a saturation segment. In some embodiments, the range module 615 may check multiple segments of the non-linear activation function till the segment including the input data element is found.

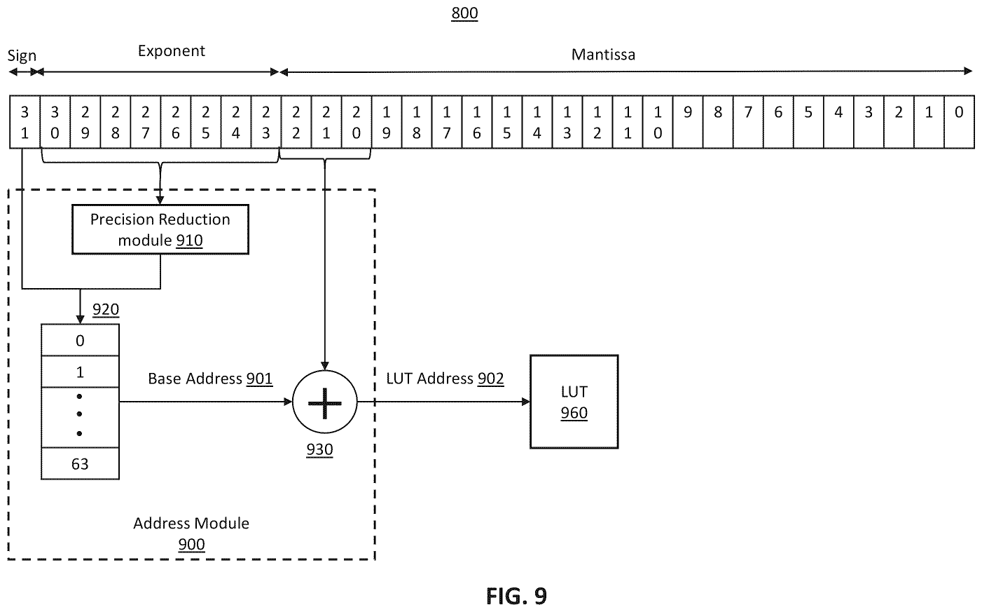

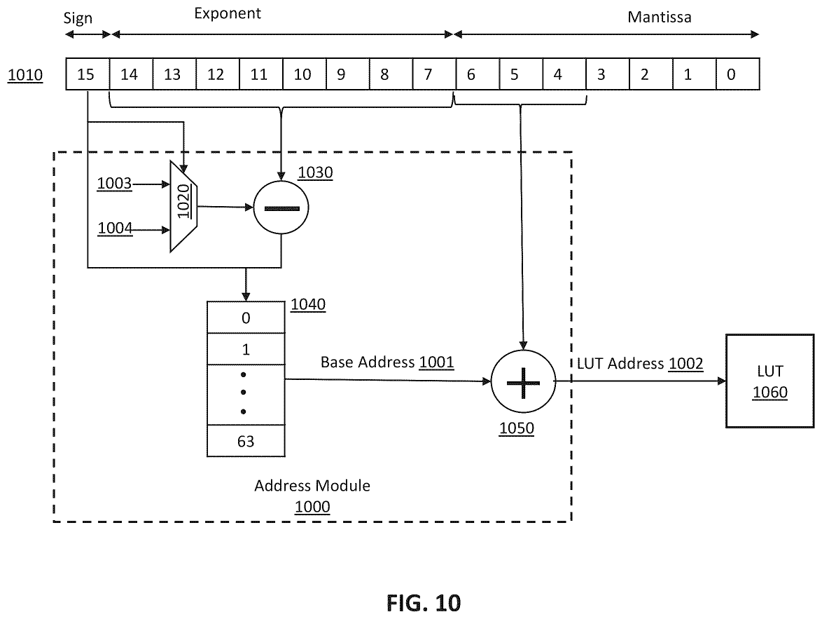

In embodiments where the range module 615 determines that the input data element falls into a linear element, the range module 615 may trigger the address module 630 to determine an address of the intercept and slope of the linear element in the LUT 640. In some embodiments, the address module 630 may determine the address based on one or more bits in the input data element. The address module 630 or the compute unit 620 may use the address to retrieve the intercept and slope from the LUT 640. For instance, the LUT 640 may include a plurality of entries. The entries may correspond to different linear segments. An entry may have a specific address and may include the intercept and slope of the corresponding linear segment. In some embodiments, the intercept and slope may be in a different data format from the input data element. For instance, the input data element may be in FP32 data format, while the intercept and slope may be in FP16 or BF16 data format. In an example, an entry may include 32 bits, the intercept has 16 bits and the slope has 16 bits. In some embodiments, the total number of entries in the LUT 640 may be a power of 2, such as 2, 4, 8, 16, 32, 64, 128, and so on. More details regarding the address in LUT are described below in conjunction with FIGS. 9 and 10.

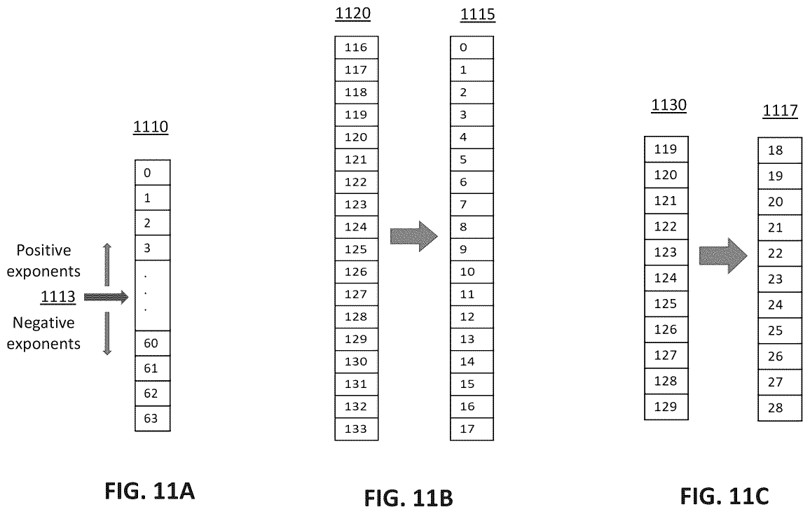

In embodiments where the range module 615 determines that the input data element falls into a saturation element, the range module 615 may trigger the saturation module 650 to identify the saturation value from the saturation table 660 based on the input data element. The saturation value is to be used as the approximated output of the activation function for all input elements falling into the saturation segment. The saturation table 660 may support multiple saturation segments. In some embodiments, each saturation segment may have a separate entry in the saturation table 660. Each entry may include a number of bits indicating the lower threshold (e.g., the minimum value) of the saturation segment, a number of bits indicating the higher threshold (e.g., the maximum value) of the saturation segment, and saturation value. In an example, an entry may include 48 bits: the lower threshold has 16 bits, the upper threshold has 16 bits, and the saturation value has 16 bits. The saturation module 650 may retrieve the fixed output from the saturation table 660 and provide the fixed output to the compute unit 620. More details regarding entries in the saturation table are described below in conjunction with FIG. 11.

Each compute unit 620 includes a multiplier 670 and an adder 680. In other embodiments, a compute unit 620 may include different, fewer, or more components. For instance, a compute unit 620 may include multiple multipliers or multiple accumulators. A compute unit 620 may have various operation modes. For instance, a compute unit 620 may have a linear function mode and a bypass mode. The operation mode of the compute units 620 may be configured by the activation function unit 610. For instance, the address module 630 may configure the compute units 620 to operate in the linear function mode, while the saturation module 650 may configure the compute units 620 to operate in the bypass mode. In some embodiments, the compute units 620 may be in the same operation mode within the same operation cycle. In other embodiments, the compute units 620 may be in different operation modes within the same operation cycle.

In the linear function mode, a compute unit 620 may compute outputs of linear functions as approximated outputs of non-linear activation functions. In an example computation cycle, the multiplier 670 may receive an increment value and a slope. The increment value may be a difference between an input data element of a non-linear activation function and a segment start value of a linear segment identified for the non-linear activation function. The slope may be the slope of a linear function for the linear segment. The multiplier 670 may compute a product of the increment value and the slope. The adder 680 receives the product from the multiplier 670 and receives an intercept of the linear function for the linear segment. The adder 680 accumulates the product and the intercept and computes an approximated output data element of the non-linear activation function. The output of the accumulator 680 may be sent out from the compute unit 620 through a data port (e.g., data output port) as a data element in an output signal 603 of the non-linear activation function. In the bypass mode, a compute unit 620 may not perform any computation. Rather, the compute unit 620 may sends out the saturation value received from the saturation table 660 as a data element in the output signal 603.

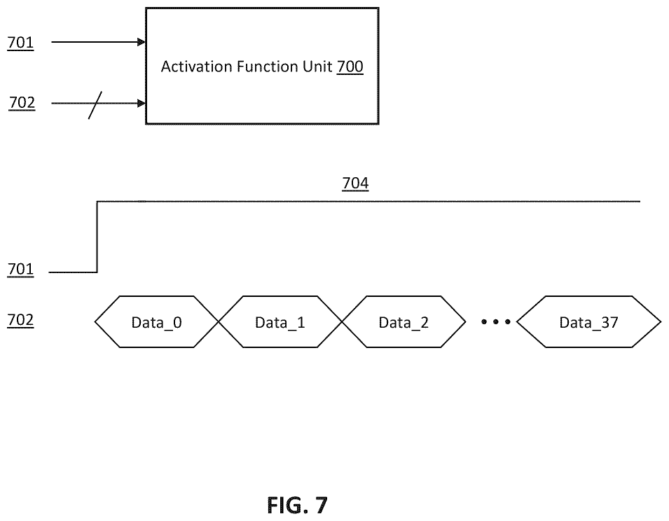

FIG. 7 illustrates an example configuration interface of an activation function unit 700, in accordance with various embodiments. The activation function unit 700 may be an example of the activation function units 520 in FIG. 5 or an example of the activation function unit 610 in FIG. 6. In the embodiments of FIG. 7, the activation function unit 700 receives a configuration enable signal 701 and a configuration data signal 702. The activation function unit 700 may receive the configuration enable signal 701 and the configuration data signal 702 from the DNN module 201, e.g., the activation function module 350. The configuration enable signal 701 may enable the program interface of the activation function unit 700 and trigger the start of a write operation 704 to write the configuration data signal 702 into a descriptor of the activation function unit 700. The configuration enable signal 701 and configuration data signal 702 may constitute a configuration signal, which may be an example of the configuration signal 601 in FIG. 6.

In an example, the configuration enable signal 701 may have one bit. In embodiments where the bit has a value of one, the data in the configuration data signal 702 may be considered valid. The write operation 704 for writing the configuration data signal 702 may be started. For the purpose of illustration, the configuration data signal 702 has 256 bits and needs 38 cycles (illustrated by “Data_0” through “Data_37”) to be written into the configuration descriptor of the activation function unit 700. In other embodiments, the configuration data signal 702 may have a different number of bits and need a different number of write cycles. In embodiments where the bit has a value of zero, the data in the configuration data signal 702 may be considered invalid. The write operation 704 for writing the configuration data signal 702 may not be started.

The configuration descriptor may be used to program one or more configurable components of the activation function unit 700. Examples of the configurable components include LUT (e.g., the LUT 640), saturation table (e.g., the saturation table 660), and so on. The configuration descriptor may include configuration parameters (e.g., configuration parameters in the configuration data signal 702) to program the configurable components. The configuration parameters may include entries to be written into the LUT, entries to be written into the saturation table, and so on.

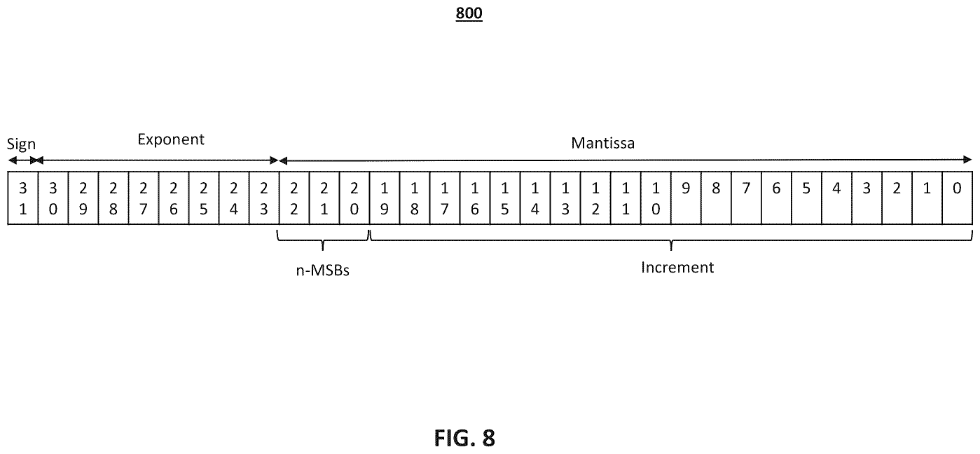

FIG. 8 illustrates an example input data element 800 of a non-linear activation function, in accordance with various embodiments. The input data element 800 may fall into a linear segment of the input range of the non-linear activation function, in which the non-linear activation function can be approximated by one or more linear functions. For the purpose of illustration, the input data element 800 has 32 bits: bits 0-31. The input data element 800 may be in FP32 data format. In other embodiments, the input data element 800 may have a different number of bits and may be in different data formats.

The most significant bit of the input data element 800 (i.e., bit 31) is the sign bit and encodes the sign of the input data element 800. The next eight bits (i.e., bits 30-23) are exponent bits and encode the exponent of the input data element 800. The other bits (i.e., bits 22-0) are mantissa bits and encode the mantissa of the input data element 800. In some embodiments, the sign bit and exponent bit may be used to determine the address of a LUT entry, such as an entry that includes the slope and intercept of the linear segment. In some embodiments, a certain number of most significant bits in the mantissa bits (e.g., bits 22-20) may also be used to determine the address of the LUT entry.

Some of the mantissa bits may encode the increment value of the input data element 800. The increment value may equal the result of subtracting the state data element (e.g., the minimum value) of the linear segment from the input data element 800. In the embodiments of FIG. 8, the bits 19-0 encode the increment value. In other embodiments, different bits in the mantissa bits may encode the increment value. The increment value may be computed by applying a mask on the input data element 800. In an example, the mask may include 32 bits with bits 31-20 having values of zero while bits 19-0 having values of one. A result of applying the mask on the input data element 800 may be the bits 19-0 in the input data element 800.

FIG. 9 illustrates determination of a LUT address 902 of a linear segment including the input data element 800, in accordance with various embodiments. The LUT address 902 is determined by an address module 900, which may be an example of the address module 630 in FIG. 6. In the embodiment of FIG. 9, the address module 900 includes a precision reduction module 910, a LUT configuration table 920, and an accumulator 930. In other embodiments, the address module 900 may include fewer, more, or different components.

The precision reduction module 910 converts exponent bits of the input data element 800 from FP32 exponent bits to FP16 exponent bits. The conversion may be denoted as:

$$exponent ( FP 16 ) = exponent ( FP 32 ) - 112$$

In embodiments where the input data element 800 is in FP16 data format, the precision reduction module 910 may not be needed. The FP16 exponent bits computed by the precision reduction module and the sign bit of the input data element 800 are input into the LUT configuration table 920 for determining a base address 901 of the linear segment including the input data element 800. The LUT configuration table 920 may include one or more LUT configuration entries corresponding to one or more linear segments of an activation function. The number of linear segments associated with the LUT configuration table 920 may be denoted as I=2ⁿ, where n may equal to 0, 1, 2, 3, 4, and so on. The LUT configuration table 920 may be indexed based on sign and exponent field in FP16 format. In some embodiments, each LUT configuration entry may have 16 bits with 6 bits encoding n and 10 bits encoding the base address of the corresponding linear segment. The LUT configuration table 920 may be a register.

The base address 901 may be retrieved from the LUT configuration table 920 based on the sign bit and the FP16 exponent bits. An offset may be determined based on a predetermined number of most significant bits in the mantissa of the input data element 800. The predetermined number is three in FIG. 9. In other embodiments, the predetermined number may be other numbers. The accumulator 930 accumulates the base address 901 with the offset and computes the LUT address 902 of the linear segment including the input data element 800. The LUT address 902 may be used to retrieve an entry in a LUT 960, i.e., the entry at the LUT address 902. The LUT 960 may be an example of the LUT 640 in FIG. 6. The entry may include the slope and intercept of the linear segment.

FIG. 10 illustrates determination of a LUT address 1002 of a linear segment including another input data element 1010, in accordance with various embodiments. Different from the input data element 800, the input data element 1010 has 16 bits with the bit 15 encoding the sign, bits 14-7 encoding the exponent, and bits 6-0 encoding the mantissa. In some embodiments, the input data element 1010 may be in BF16 format. The LUT address 1002 is determined by an address module 1000, which may be an example of the address module 630 in FIG. 6. In the embodiment of FIG. 10, the address module 1000 includes a MUX 1020, a subtractor 1030, a LUT configuration table 1040, and an accumulator 1050. In other embodiments, the address module 1000 may include fewer, more, or different components.

The MUX 1020 receives a positive offset, a negative offset, and the sign bit of the input data element 1010. The sign bit may determine which offset is output from the MUX 1020. For instance, when the sign bit indicates a positive sign of the input data element 1010, the positive offset is output from the MUX 1020; versus when the sign bit indicates a negative sign of the input data element 1010, the negative offset is output from the MUX 1020. The offset output from the MUX 1020 and the sign bit of the input data element 1010 are provided to the LUT configuration table 1040 for determining a base address 1001 of the linear segment including the input data element 800.

In some embodiments, the base address 1001 may be retrieved from the LUT configuration table 1040 based on the sign bit and the FP16 exponent bits. The LUT configuration table 1040 may include one or more LUT configuration entries corresponding to one or more linear segments of an activation function. The number of linear segments associated with the LUT configuration table 1040 may be denoted as I=2″, where n may equal to 0, 1, 2, 3, 4, and so on. The LUT configuration table 1040 may be indexed based on sign and exponent field in FP16 format. In some embodiments, each LUT configuration entry may have 16 bits with 6 bits encoding n and 10 bits encoding the base address of the corresponding linear segment.

An offset may be determined based on a predetermined number of most significant bits in the mantissa of the input data element 800. The predetermined number is three in FIG. 10. In other embodiments, the predetermined number may be other numbers. The accumulator 1050 accumulates the base address 1001 with the offset and computes the LUT address 1002 of the linear segment including the input data element 800.

The LUT address 1002 may be used to retrieve an entry in a LUT 1060, i.e., the entry at the LUT address 1002. The LUT 1060 may be an example of the LUT 640 in FIG. 6. The entry may include the slope and intercept of the linear segment. In some embodiments, the LUT 640 may have sufficient storage space to store the number of LUT entries needed by BF16 data format. For instance, the total number of BF16 entries may be 374 in embodiments where input data elements in BF16 format may be in a range from −7.968 to 88.5 (e.g., including −7.968 and 88.5) and the range of output data elements may be in a range from 0 to 1.5972398e³². The LUT 1060 may have a size of 512 entries. In other embodiments, the size of the LUT 1060 may be smaller than 374. For instance, the size of the LUT 1060 may be 256. For such embodiments, multiple configuration descriptors may be used. For instance, a first configuration descriptor may support output data elements in a range from 0 to 8.35e⁶, and a second configuration descriptor may support output data elements in a range from 8.35e⁶ to 1.5972398e³². Additionally or alternatively, the range of the output data elements may be reduced. For instance, the range of the output data elements may be reduced to a range from 55.9 to 1.5972398e³².

FIGS. 11A-11C illustrate mapping of BF16 exponents to LUT configuration entries, in accordance with various embodiments. FIG. 11A shows a LUT configuration table 1110 including 64 LUT configuration entries having indexes of 0-63. The LUT configuration table 1110 may be an example of the LUT configuration table 1040 in FIG. 10. Some of the LUT configuration entries are for positive exponents. The rest of the LUT configuration entries are for negative exponents. In an example, the first half of the LUT configuration table 1110 may be used for positive exponents, and the second half may be used for negative exponents. In another example, the first N (N may be an integer, such as 10, 15, 20, etc.) entries in the LUT configuration table 1110 may be used for positive exponents, and some of or all the other entries may be used for negative exponents. The split of LUT configuration table 1110 between the positive range of exponents and the negative range of exponents may be flexible to support a bigger range in either the positive region or the negative region.

In some embodiments, the LUT configuration table 1110 is implemented with a boundary 1113 that splits the LUT configuration table 1110 into a positive section for storing positive exponents and a negative section for storing negative exponents. The boundary 1113 may be programmable, as opposed to being fixed. For instance, the DNN module 201 (e.g., the activation function module 350) may configure the boundary 113 based on the complexity of function in the positive and negative range. For example, for ELU, the positive range may involve passing the input directly to the output which could be implemented by using bypass feature of the activation function unit(s) in the PPE array. This leaves the complete LUT available for the negative range, allowing better accuracy (e.g., better unit of least precision) in the approximation for the activation function by having a greater number of entries for the negative range.

FIG. 11B shows a positive exponent range 1120 mapped to a portion 1115 of the LUT configuration table 1110. The positive exponent range 1120 includes positive BF16 exponents. The positive BF16 exponents have a positive offset. In the embodiments of FIG. 11B, the positive offset is 116. In other embodiments, the positive offset may be different.

FIG. 11C shows a negative exponent range 1130 mapped to another portion 1115 of the LUT configuration table 1110. The negative exponent range 1130 includes negative BF16 exponents. The negative BF16 exponents may have a negative offset. In the embodiments of FIG. 11C, the negative offset is 101. In other embodiments, the negative offset may be different.

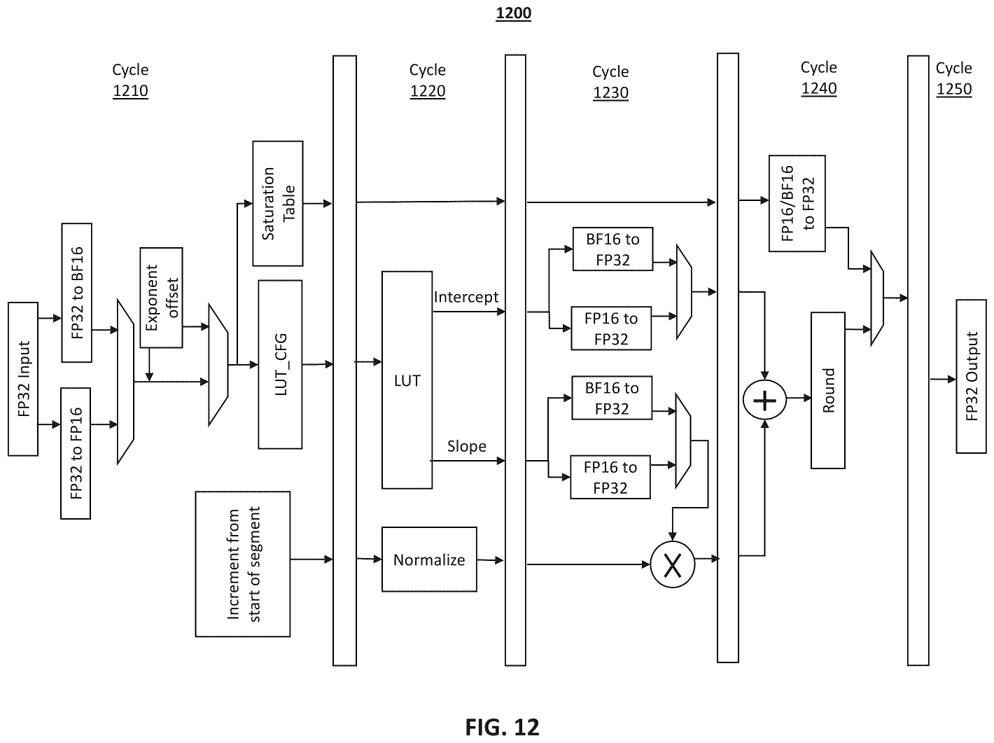

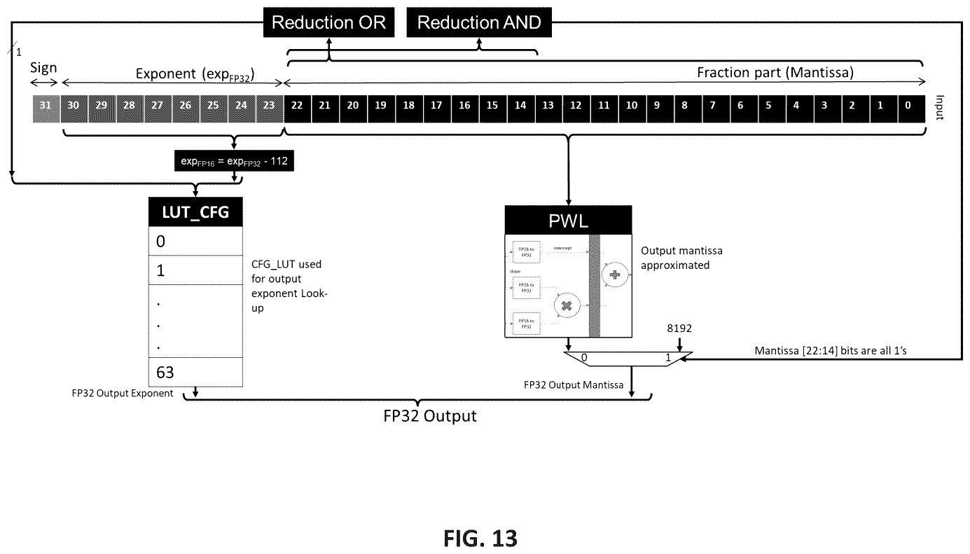

FIG. 12 illustrates a pipeline 1200 of approximating a non-linear activation function, in accordance with various embodiments. The pipeline 1200 may be performed by a PPE array, such as the PPE array 260 in FIG. 2 or the PPE array 500 in FIG. 5. In the embodiments of FIG. 12, the pipeline 1200 includes five cycles: 1210, 1220, 1230, 1240, and 1250. In other embodiments, the pipeline 1200 may include fewer, more, or different cycles. The pipeline 1200 facilitates input in various formats, such as FP32, FP16, BF16, and so on.

In the cycle 1210, an FP32 input is received. The FP32 input may include an input data element in FP32 format, such as the input data element 800 in FIG. 8. The FP32 input data element is converted to FP16 or BF16 data element. In embodiments where the FP32 input data element is converted to BF16 data element, an exponent offset is applied. Then the data is provided to a LUT configuration table or a saturation table. For instance, in embodiments where the FP32 input data element falls into a linear segment, the LUT configuration table may be used to determine an address of a LUT entry. In embodiments where the FP32 input data element falls into a saturation segment, the saturation table may be used to determine a saturation value. Also, an increment from the start of the segment is determined.

In the cycle 1220, the address determined using the LUT configuration table is used to retrieve an entry in an LUT. The intercept and slope of the linear segment may be retrieved from the LUT based on the address. The intercept and slope may be both in FP16 or BF16 format. The increment from the start of the segment may be normalized. In embodiments where the FP32 input data element falls into a saturation segment, the saturation value may be forwarded to the cycle 1230.

In the cycle 1230, the data format of the intercept and slope are converted to FP32. A multiplier multiplies the normalized increment by the slope. The product of the normalized increment and the slope may be in FP32 format. In embodiments where the FP32 input data element falls into a saturation segment, the saturation value may be forwarded to the cycle 1240.

In the cycle 1240, an accumulator accumulates the intercept and the product of the normalized increment and the slope to compute a sum. The sum is rounded. In embodiments where the FP32 input data element falls into a saturation segment, the data format of the saturation value is changed to FP32. The rounded sum or the FP32 saturation value is forwarded to the cycle 1250.

In the cycle 1250, the rounded sum or the FP32 saturation value is output from the PPE array as an approximated output of the non-linear activation function. The approximated output of the output of the non-linear activation function may be a FP32 data element.

Various embodiments described above relate to approximating both the exponent and mantissa of an output data element of an activation function using a linear function. In other embodiments, the mantissa of an output data element of an activation function may be approximated e.g., by using reciprocal function, inverse square root function, etc., while the exponent of the output data element may be determined using a LUT configuration table.

FIG. 13 illustrates approximating an activation function with a reciprocal function, in accordance with various embodiments. A LUT configuration table (shown as “LUT_CFG” in FIG. 13) may store the output exponent corresponding to FP16 input exponent. For reciprocal, two sets of output exponents may be needed considering the special case of all mantissa bits equal to zero. In embodiments where all the FP16 mantissa bits equal to 1, the output mantissa may be a fixed value. The configuration descriptor may be used for programming a reciprocal function onto an activation function unit (e.g., the activation function unit 610). The configuration description may include data corresponding to the output exponent for the case of mantissa equal to 0. The configuration description may also include data corresponding to the output exponents for the case of mantissa not equal to zero. In some embodiments, the configuration description may further include data corresponding to the slope and intercept for approximating output mantissa when all the input mantissa bits are equal to zero. The configuration description may also include data corresponding to the slope and intercepts for the case mantissa bits are nonzero. In some embodiments, the configuration description may include a symmetric bit that is set given that a reciprocal function may be symmetric with respect to positive input data element and negative data elements, which may be denoted as:

$$Reciprocal ( - x ) = - Reciprocal ( x )$$

where is x denotes input to the activation function.

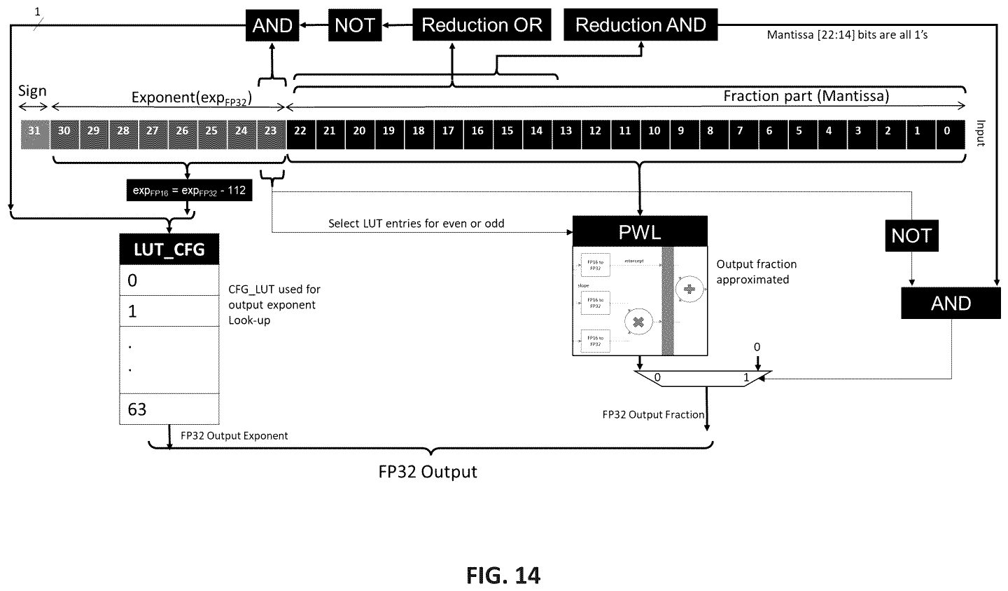

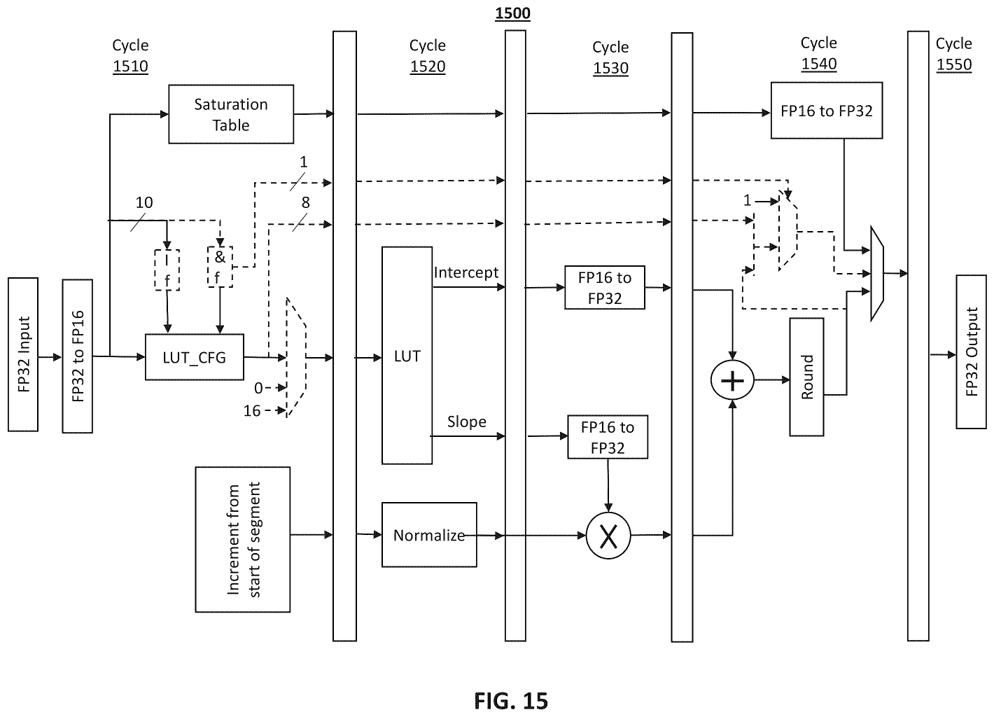

FIG. 14 illustrates approximating an activation function with an inverse square root function, in accordance with various embodiments. Similar to the implementation for reciprocal approximation in FIG. 13, output exponents for the inverse square root function may be stored in a LUT configuration table (shown as “LUT_CFG” in FIG. 15). Two sets of output exponents may be required: one set for the even input exponents and the second set for the odd input exponents. Similarly, two sets of slopes and intercepts may be required: one set is for even input exponents and the other set for odd input exponents.

FIG. 15 illustrates a pipeline 1500 for approximating the mantissa part of an output data element of an activation function, in accordance with various embodiments. The mantissa part of the output data element may be approximated using a reciprocal function or inverse square root function, such as the ones described above. The pipeline 1500 may be performed by a PPE array, such as the PPE array 260 in FIG. 2 or the PPE array 500 in FIG. 5. In the embodiments of FIG. 15, the pipeline 1500 includes five cycles: 1510, 1520, 1530, 1540, and 1550. In other embodiments, the pipeline 1500 may include fewer, more, or different cycles.

In the embodiments of FIG. 15, the pipeline 1500 includes data paths to support approximation of mantissa part of activation function output with reciprocal and inverse square root functions. These additional data paths and components on the additional data paths are shown by dash lines in FIG. 15. The additional data paths include a path from LUT_CFG to the P32 output. This path bypasses the logic units for approximating the activation function with a linear function (e.g., the LUT, multiplier, accumulator, etc.) and passes the output exponent retrieved from the LUT_CFG to the output. Also, the additional data paths include logic units to detect whether the input mantissa is equal to zero or whether the input mantissa bits are all ones.

For the purpose of illustration and simplicity, the pipeline 1500 is for processing an input data element in FP32 format, such as the input data element 800 in FIG. 8. The FP32 input data element is converted to FP16 data element during the pipeline 1500. The LUT configuration table, saturation table, and LUT in the pipeline 1500 support FP16 data format. In other embodiments, the input data element may be in a different data format. Alternatively or additionally, the LUT configuration table, saturation table, and LUT in the pipeline 1500 may support other data formats, such as BF16 data format. The pipeline 1500 may include additional data paths for facilitating BF16 data formats, such as the ones shown in FIG. 12.

FIG. 16 illustrates an example configuration descriptor 1600 for approximating a non-linear activation function, in accordance with various embodiments. The configuration descriptor 1600 may be used to compute approximated outputs of the non-linear activation function. In some embodiments, the configuration descriptor 1600 may be generated by the DNN module 201, e.g., the activation function module 350. The configuration descriptor 1600 may be stored in various memories, e.g., the memory 210, the local memory 240, memories (e.g., register files) inside the PPE array 260, and so on. In the embodiments of FIG. 16, the configuration descriptor 1600 includes a LUT_CFG 1610, a LUT 1620, and a register 1630. In other embodiments, the configuration descriptor 1600 may include fewer, more, or different components. The components of the configuration descriptor 1600 may be stored separately. For instance, the components of the configuration descriptor 1600 may be stored in different memories, e.g., in different register files.

The LUT configuration table 1610 stores LUT configuration parameters. In the embodiments of FIG. 16, the LUT configuration table 1610 includes 64 entries: LUT_CFG_0 through LUT_CFG_64. Each entry includes 16 bits. In other embodiments, the LUT configuration table 1610 may include a different number of entries. Also, an entry may include a different number of bits. Each entry may encode a value and a base address. The value may indicate the number of linear segments of the non-linear activation function. The base address may be used to compute a LUT address of a linear segment. The LUT configuration table 1610 may be a LUT configuration register. The LUT configuration table 1610 may be an example of the LUT configuration table 920 in FIG. 9, the LUT configuration table 1040 in FIG. 10, the LUT configuration table 1110 in FIG. 11A, the LUT_CFG in FIG. 12, the LUT_CFG in FIG. 13, the LUT_CFG in FIG. 14, or the LUT_CFG in FIG. 15.

The LUT 1620 stores intercepts and slopes of the linear segments. In the embodiments of FIG. 16, the LUT 1620 has 256 entries: LUT_0 through LUT_255. Each entry may encode the intercept and slope of a different linear segment from the other entries. The LUT 1620 may support various data formats. The intercepts and slopes may be in FP16 format, BF16 format, or other formats. The LUT 1620 may be an example of the LUT 640 in FIG. 6, the LUT 960 in FIG. 9, the LUT 1060 in FIG. 10, the LUT in FIG. 12, or the LUT in FIG. 15.

The register 1630 includes a saturation table, a symmetric bit, an RCP bit, and a RSQT bit. The saturation table includes seven saturation entries in FIG. 16. Each saturation entry may encode the range of a saturation segment (e.g., the minimum value and maximum value of the range) and the saturation value of the saturation segment. In other embodiments, the register 1630 may include a different number of saturation entries.

The symmetric bit indicates whether the approximated outputs of the non-linear activation function are symmetric with respect to zero or not. The approximated outputs are symmetric with respect to zero when the approximated output of a positive input has the same absolute value as but opposite sign from the approximated output of a negative input that has the same absolute value as the positive input. The symmetric bit, when enabled, may indicate that the approximated outputs of the non-linear activation function are symmetric. In embodiments where the symmetric bit is enabled (e.g., the symmetric bit has a value of one), the approximation for negative inputs (or positive inputs) may be bypassed and the approximated outputs may be determined by changing the sign of the approximated outputs of the corresponding positive inputs (or negative inputs).

The RCP bit encodes whether a reciprocal function is to be used to approximate output for one or more segments of the non-linear activation function. The RCP bit, when enabled, may indicate that a reciprocal function is used. In embodiments where the RCP bit is enabled (e.g., the RCP bit has a value of one), the mantissa part of each output data element may be approximated using the reciprocal function and the exponent part of each output data element may be retrieved from the LUT 1620.

The RSQT bit encodes whether an inverse square root function is to be used to approximate output for one or more segments of the non-linear activation function. The RSQT bit, when enabled, may indicate that an inverse square root function is used. In embodiments where the RSQT bit is enabled (e.g., the RSQT bit has a value of one), the mantissa part of each output data element may be approximated using the inverse square root function and the exponent part of each output data element may be retrieved from the LUT 1620.

### Example Methods of Executing Activation Functions

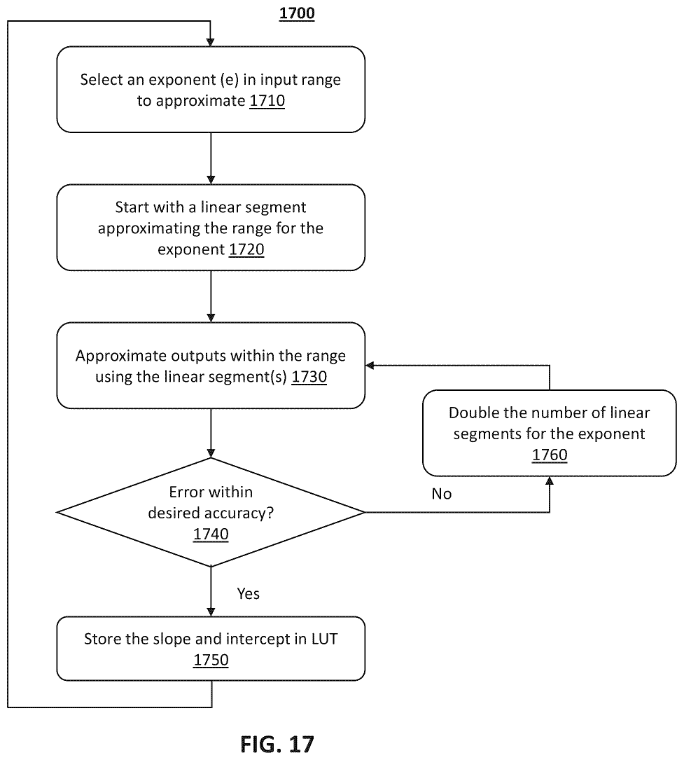

FIG. 17 is a flowchart showing a method 1700 of approximating a non-linear activation function in a DNN, in accordance with various embodiments. The method 1700 may be performed by the activation function module 350 in FIG. 3. Although the method 1700 is described with reference to the flowchart illustrated in FIG. 17, many other methods for executing activation functions may alternatively be used. For example, the order of execution of the steps in FIG. 17 may be changed. As another example, some of the steps may be changed, eliminated, or combined.

In Step 1710, an exponent in an input range to approximate is selected. The input range may be the range of values of all possible input data elements of the non-linear activation function. The input range may depend on the data format of the input data elements. For instance, the input range for FP32 data elements may include a positive range from approximately 1.18e⁻³⁸ to approximately 3.40e⁺³⁸ and a negative range from approximately −3.40e⁺³⁸ to approximately −1.18e⁻³⁸. The input range for FP16 data elements may include a positive range from approximately 6.10e⁻⁰⁵ to approximately 6.55e⁺⁰⁴ and a negative range from approximately −6.55e⁺⁰⁴ to approximately −6.10e⁻⁰⁵. The input range for BF16 data elements may include a positive range from approximately 1.18e⁻³⁸ to approximately 3.39e⁺³⁸ and a negative range from approximately −3.39e⁺³⁸ to approximately −1.18e⁻³⁸.

In Step 1720, a linear segment is started for approximating the range for the selected exponent. The linear segment may correspond to a linear function having a slope and an intercept.

In Step 1730, outputs within the range are approximated using the linear segment. For instance, input data elements falling into the linear segment are processed using the linear function. Outputs of the linear function are used as approximated outputs of the non-linear activation function.

In Step 1740, it is determined whether an error of the approximated outputs is within a desired accuracy. The error may be a difference between the approximated outputs and real outputs of the non-linear activation function. The desired accuracy may be a unit of least precision. Unit of least precision is also referred to as unit in the last place and may be used as a measure of accuracy. Unit of least precision indicates the spacing between two consecutive floating-point numbers. Unit of least precision may be the value represented by the least significant digit (i.e., the right most digit) when it is 1. Unit of least precision may be different for different exponents. Instance, the unit of least precision for an exponent having a value of 15 may be approximately 0.0009765625, the unit of least precision for an exponent having a value of 23 may be approximately 0.25.

In embodiments where the error is within the desired accuracy, Step 1750 is performed, in which the slope and intercept of the linear segment are stored in a LUT, e.g., the LUT 1620 in FIG. 16. The slope and intercept may be stored together as a single entry in the LUT.

In embodiments where the error is not within the desired accuracy, Step 1760 is performed, in which the number of linear segments for the exponent is doubled. For instance, the linear segment is partitioned into two new linear segments corresponding to two different linear functions. In other embodiments, the linear segment may be partitioned into more than two new linear segments. For each of the new linear segments, Step 1730 is performed. Subsequent steps may be performed too till the desired accuracy is achieved in Step 1740 and the slope and intercept are stored in the LUT in Step 1750.

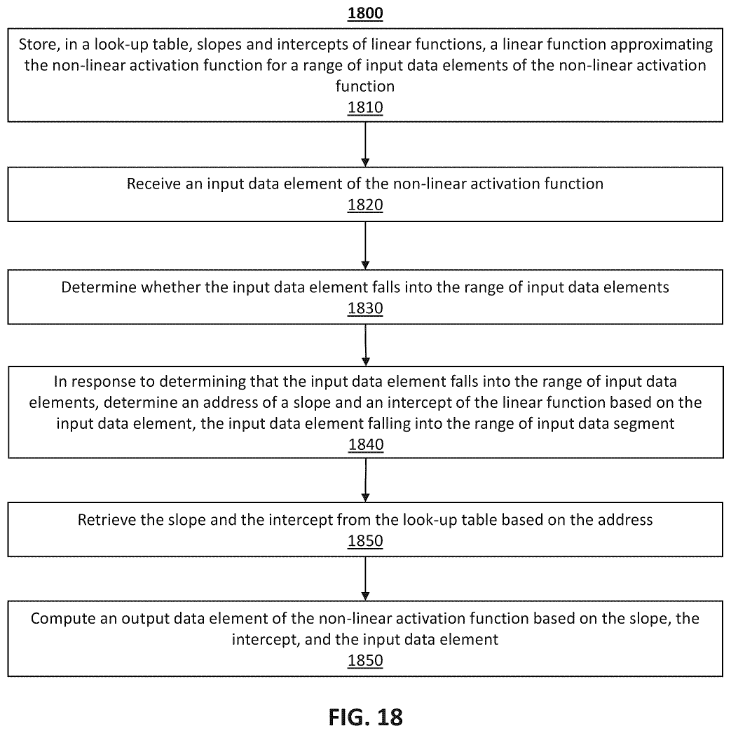

FIG. 18 is a flowchart showing a method 1800 of executing a non-linear activation function in a DNN, in accordance with various embodiments. The method 1800 may be performed by the PPE array 500 in FIG. 5. Although the method 1800 is described with reference to the flowchart illustrated in FIG. 18, many other methods for executing activation functions may alternatively be used. For example, the order of execution of the steps in FIG. 18 may be changed. As another example, some of the steps may be changed, eliminated, or combined.

The PPE array 500 stores 1810, in a LUT, slopes and intercepts of linear functions. A linear function approximates the non-linear activation function for a range of input data elements of the non-linear activation function. The range of input data elements may correspond to a linear segment of the non-linear activation function. The input range of the non-linear activation function may include other segments, such as saturation segments or other linear segments.

The PPE array 500 receives 1820 an input data element of the non-linear activation function. In some embodiments, the input data element has a bit indicating a sign of the input data element, one or more bits indicating an exponent of the input data element, and one or more bits indicating a mantissa of the input data element.

The PPE array 500 determines 1830 whether the input data element falls into the range of input data elements. For instance, the PPE array 500 determines whether the input data element has a value that is no less than the minimum value in the range and no greater than the maximum value in the range.

The PPE array 500 determines 1840 an address of a slope and an intercept of the linear function based on the input data element, in response to determining that the input data element falls into the range of input data elements. The input data element falls into the range of input data segment. In some embodiments, the PPE array 500 determines the address of the slope and the intercept of the linear data segment based on the bit indicating the sign of the input data element and the one or more bits indicating the exponent of the input data element. In some embodiments, the PPE array 500 determines the address of the slope and the intercept of the linear data segment further based on one or more most significant bits of the plurality of bits indicating the mantissa of the input data element.

In some embodiments, the PPE array 500 reduces the precision of the input data element by changing a first data format of the input data element to a second data format. The precision of the input data element is reduced before the address of the slope and the intercept of the linear data segment is determined based on the input data element. In some embodiments, the output input element is in the first data format. The first data format is FP32 data format. The second data format is FP16 data format or BF16 data format.

The PPE array 500 retrieves 1850 the slope and the intercept from the LUT based on the address.

The PPE array 500 computes 1860 an output data element of the non-linear activation function based on the slope, the intercept, and the input data element. The output data element may be an approximated output of the non-linear activation function. In some embodiments, the PPE array 500 computes the output data element of the non-linear activation function based on the slope, the intercept, and one or more least significant bits of the one or more bits indicating the mantissa of the input data element.

In some embodiments, the PPE array 500 determines whether the input data element falls into a different range of input data elements of the non-linear activation function. After determining that the input data element falls into the different range of input data elements, the PPE array 500 uses a predetermined value as a different output data element of the non-linear activation function.

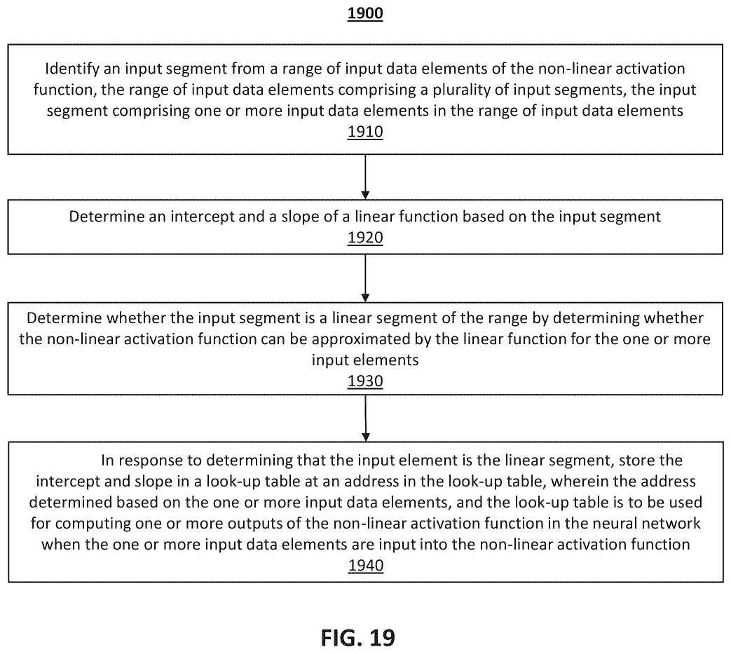

FIG. 19 is a flowchart showing another method 1900 for approximating a non-linear activation function in a DNN, in accordance with various embodiments. The method 1900 may be performed by the activation function unit 600 in FIG. 3. Although the method 1900 is described with reference to the flowchart illustrated in FIG. 19, many other methods for executing activation functions may alternatively be used. For example, the order of execution of the steps in FIG. 19 may be changed. As another example, some of the steps may be changed, eliminated, or combined.

The activation function module 350 identifies 1910 an input segment from a range of input data elements of the non-linear activation function. The range of input data elements comprises a plurality of input segments. The input segment comprises one or more input data elements in the range of input data elements. In some embodiments, the activation function module 350 identifies the input segment by selecting an exponent in the range of input data elements as the input segment. In some embodiments, an input data element has a bit indicating a sign of the input data element, one or more bits indicating an exponent of the input data element, and one or more bits indicating a mantissa of the input data element.

The activation function module 350 determines 1920 an intercept and a slope of a linear function based on the input segment.

The activation function module 350 determines 1930 whether the input segment is a linear segment of the range by determining whether the non-linear activation function can be approximated by the linear function for the one or more input elements. In some embodiments, the activation function module 350 determines whether the input segment is the linear segment by computing an error of approximating the non-linear activation function with the linear function and determining whether the error is greater than a predetermined threshold. In some embodiments, the predetermined threshold is a unit of least precision determined based on a spacing between two consecutive floating-point numbers in a floating-point data format.

In some embodiments, in response to determining that the error is greater than the predetermined threshold, the activation function module 350 partitions the input segment into a plurality of new input segments. The activation function module 350 determines whether a new input segment is a linear segment.

The activation function module 350 stores 1940 the intercept and slope in a LUT at an address in the LUT in response to determining that the input segment is the linear segment. The address is determined based on the one or more input data elements. The LUT is to be used for computing one or more outputs of the non-linear activation function in the DNN when the one or more input data elements are input into the non-linear activation function. In some embodiments, the address is determined based on the bit indicating the sign of the input data element and the one or more bits indicating the exponent of the input data element. In some embodiments, the address is determined further based on one or more most significant bits of the plurality of bits indicating the mantissa of the input data element.

In some embodiments, after storing the intercept and slope in the LUT, the activation function module 350 identifies another input segment from the range of input data elements by incrementing the exponent. The activation function module 350 determines whether the another input segment is another linear segment.

In some embodiments, the activation function module 350 determines whether an input segment is a saturation segment based on the one or more input data elements. In response to determining that the input segment is the saturation segment, the activation function module 350 stores a value in a saturation table. The value is to be used as an output of the non-linear activation function in the DNN when the one or more input data elements are input into the non-linear activation function.

### Example Computing Device

FIG. 20 is a block diagram of an example computing device 2000, in accordance with various embodiments. In some embodiments, the computing device 2000 can be used as at least part of the DNN system 200, such as the DNN module 201 in the DNN system 200. A number of components are illustrated in FIG. 20 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single system on a chip (SoC) die. Additionally, in various embodiments, the computing device 2000 may not include one or more of the components illustrated in FIG. 20, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008, but may include audio input or output device interface circuitry (e.g., connectors and supporting circuitry) to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The computing device 2000 may include a memory 2004, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to perform operations for executing activation functions in DNNs, e.g., the method 1700 described above in conjunction with FIG. 17, the method 1800 described above in conjunction with FIG. 18, the method 1900 described above in conjunction with FIG. 19, or some operations performed by the DNN system 200 (e.g., the DNN module 201 or the PPE array 260) described above in conjunction with FIG. 2. The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

### SELECT EXAMPLES

The following paragraphs provide various examples of the embodiments disclosed herein.

Example 1 provides an apparatus for executing a neural network, the apparatus including a data port to receive an input data element of a function in the neural network; a look-up table to store one or more parameters of an approximation of the function over a range of input data elements of the function; an address module to determine, based on the input data element, an address of at least one parameter of the function; and a compute unit including a multiplier and an accumulator, the compute unit to: receive the one or more parameters of the function from the look-up table based on the address, and compute an output data element of the function based on the one or more parameters of the function and the input data element.

Example 2 provides the apparatus of example 1, in which the function in the neural network is a non-linear activation function for the range of input data elements, and the approximation of the non-linear activation function for the range of input data elements of the function includes a linear function.

Example 3 provides the apparatus of example 2, in which the one or more parameters include a slope and an intercept of the linear function.

Example 4 provides the apparatus of any one of examples 1-3, in which the input data element has a bit indicating a sign of the input data element, one or more bits indicating an exponent of the input data element, and one or more bits indicating a mantissa of the input data element.

Example 5 provides the apparatus of example 4, in which the compute unit is to compute the output data element based on the one or more parameters and one or more least significant bits of the one or more bits indicating the mantissa of the input data element.

Example 6 provides the apparatus of example 4 or 5, in which the address module is to determine the address based on the bit indicating the sign of the input data element and the one or more bits indicating the exponent of the input data element.

Example 7 provides the apparatus of example 6, in which the address module is to determine the address further based on one or more most significant bits of the plurality of bits indicating the mantissa of the input data element.

Example 8 provides the apparatus of any one of examples 1-7, further including a precision adjustment module to reduce a precision of the input data element by changing a first data format of the input data element to a second data format, in which the precision of the input data element is reduced before the address is determined based on the input data element.

Example 9 provides the apparatus of example 8, in which the output input element is in the first data format.

Example 10 provides the apparatus of any one of examples 1-9, further including a saturation module to: determine whether the input data element falls into a different range of input data elements of the function, and after determining that the input data element falls into the different range of input data elements, causing the compute unit to output a predetermined value as a different output data element of the function.

Example 11 provides a method for executing a neural network, the method including receiving an input data element of a function in the neural network; storing, in a look-up table, one or more parameters of an approximation of the function over a range of input data elements of the function; determining whether the input data element falls into the range of input data elements; and in response to determining that the input data element falls into the range of input data elements: determining an address of at least one parameter of the function based on the input data element, retrieving the one or more parameters of the function from the look-up table based on the address, and computing an output data element of the function based on the received one or more parameters of the function and the input data element.

Example 12 provides the method of example 11, in which the function in the neural network is a non-linear activation function for the range of input data elements, and the approximation of the non-linear activation function for the range of input data elements of the function includes a linear function.

Example 13 provides the method of example 11 or 12, in which the input data element has a bit indicating a sign of the input data element, one or more bits indicating an exponent of the input data element, and one or more bits indicating a mantissa of the input data element.

Example 14 provides the method of example 13, in which computing the output data element includes computing the output data element based on the one or more parameters and one or more least significant bits of the one or more bits indicating the mantissa of the input data element.

Example 15 provides the method of example 13 or 14, in which determining the address includes determining the address based on the bit indicating the sign of the input data element and the one or more bits indicating the exponent of the input data element.

Example 16 provides the method of any one of examples 11-15, further including reducing a precision of the input data element by changing a first data format of the input data element to a second data format, in which the precision of the input data element is reduced before the address is determined based on the input data element.

Example 17 provides the method of any one of examples 11-16, further including determine whether the input data element falls into a different range of input data elements of the function, and after determining that the input data element falls into the different range of input data elements, using a predetermined value as a different output data element of the function.

Example 18 provides one or more non-transitory computer-readable media storing instructions executable to perform operations for executing a non-linear activation function in a neural network, the operations including receiving an input data element of a function in the neural network; storing, in a look-up table, one or more parameters of an approximation of the function over a range of input data elements of the function; determining whether the input data element falls into the range of input data elements; and in response to determining that the input data element falls into the range of input data elements: determining an address of at least one parameter of the function based on the input data element, retrieving the one or more parameters of the function from the look-up table based on the address, and computing an output data element of the function based on the received one or more parameters of the function and the input data element.

Example 19 provides the one or more non-transitory computer-readable media of example 18, in which the function in the neural network is a non-linear activation function for the range of input data elements, and the approximation of the non-linear activation function for the range of input data elements of the function includes a linear function.

Example 20 provides the one or more non-transitory computer-readable media of example 18 or 19, in which the operations further include determine whether the input data element falls into a different range of input data elements of the function, and after determining that the input data element falls into the different range of input data elements, using a predetermined value as a different output data element of the function.

### ADDITIONAL SELECT EXAMPLES

The following paragraphs provide various examples of the embodiments disclosed herein.

Example 1 provides an apparatus for executing a non-linear activation function in a neural network, the apparatus including a LUT to store slopes and intercepts of linear functions, a linear function approximating the non-linear activation function for a range of input data elements of the non-linear activation function; a data port to receive an input data element of the non-linear activation function; an address module to determine an address of a slope and an intercept of the linear function based on the input data element, the input data element falling into the range of input data segment; a compute unit including a multiplier and an accumulator, the compute unit to: receive the slope and the intercept from the LUT based on the address, and compute an output data element of the non-linear activation function based on the slope, the intercept, and the input data element.

Example 2 provides the apparatus of example 1, in which the input data element has a bit indicating a sign of the input data element, one or more bits indicating an exponent of the input data element, and one or more bits indicating a mantissa of the input data element.

Example 3 provides the apparatus of example 2, in which the compute unit is to compute the output data element of the non-linear activation function based on the slope, the intercept, and one or more least significant bits of the one or more bits indicating the mantissa of the input data element.

Example 4 provides the apparatus of example 2 or 3, in which the address module is to determine the address of the slope and the intercept of the linear data segment based on the bit indicating the sign of the input data element and the one or more bits indicating the exponent of the input data element.

Example 5 provides the apparatus of example 4, in which the address module is to determine the address of the slope and the intercept of the linear data segment further based on one or more most significant bits of the plurality of bits indicating the mantissa of the input data element.

Example 6 provides the apparatus of any one of examples 1-5, further including a precision adjustment module to reduce a precision of the input data element by changing a first data format of the input data element to a second data format, in which the precision of the input data element is reduced before the address of the slope and the intercept of the linear data segment is determined based on the input data element.

Example 7 provides the apparatus of example 6, in which the output input element is in the first data format.

Example 8 provides the apparatus of example 6 or 7, in which the first data format is FP32 data format, and the second data format is FP16 data format or BF16 data format.

Example 9 provides the apparatus of any one of examples 1-8, further including a saturation module to: determine whether the input data element falls into a different range of input data elements of the non-linear activation function, and after determining that the input data element falls into the different range of input data elements, causing the compute unit to output a predetermined value as a different output data element of the non-linear activation function.

Example 10 provides the apparatus of any one of examples 6-8, in which a total number of the linear data segments is a power of two.

Example 11 provides a method for executing a non-linear activation function in a neural network, the method including storing, in a LUT, slopes and intercepts of linear functions, a linear function approximating the non-linear activation function for a range of input data elements of the non-linear activation function; receiving an input data element of the non-linear activation function; determining whether the input data element falls into the range of input data elements; and in response to determining that the input data element falls into the range of input data elements: determining an address of a slope and an intercept of the linear function based on the input data element, the input data element falling into the range of input data segment, retrieving the slope and the intercept from the LUT based on the address, and computing an output data element of the non-linear activation function based on the slope, the intercept, and the input data element.

Example 12 provides the method of example 11, in which the input data element has a bit indicating a sign of the input data element, one or more bits indicating an exponent of the input data element, and one or more bits indicating a mantissa of the input data element.

Example 13 provides the method of example 12, in which computing the output data element of the non-linear activation function includes computing the output data element of the non-linear activation function based on the slope, the intercept, and one or more least significant bits of the one or more bits indicating the mantissa of the input data element.

Example 14 provides the method of example 12 or 13, in which determining the address of the slope and the intercept of the linear data segment includes determining the address of the slope and the intercept of the linear data segment based on the bit indicating the sign of the input data element and the one or more bits indicating the exponent of the input data element.

Example 15 provides the method of any one of examples 11-14, further including reducing a precision of the input data element by changing a first data format of the input data element to a second data format, in which the precision of the input data element is reduced before the address of the slope and the intercept of the linear data segment is determined based on the input data element.

Example 16 provides the method of example 15, in which the output input element is in the first data format, the first data format is FP32 data format, and the second data format is FP16 data format or BF16 data format.

Example 17 provides the method of any one of examples 11-16, further including determine whether the input data element falls into a different range of input data elements of the non-linear activation function, and after determining that the input data element falls into the different range of input data elements, using a predetermined value as a different output data element of the non-linear activation function.

Example 18 provides one or more non-transitory computer-readable media storing instructions executable to perform operations for executing a non-linear activation function in a neural network, the operations including storing, in a LUT, slopes and intercepts of linear functions, a linear function approximating the non-linear activation function for a range of input data elements of the non-linear activation function; receiving an input data element of the non-linear activation function; determining whether the input data element falls into the range of input data elements; and in response to determining that the input data element falls into the range of input data elements: determining an address of a slope and an intercept of the linear function based on the input data element, the input data element falling into the range of input data segment, retrieving the slope and the intercept from the LUT based on the address, and computing an output data element of the non-linear activation function based on the slope, the intercept, and the input data element.

Example 19 provides the one or more non-transitory computer-readable media of example 18, in which: the input data element has a bit indicating a sign of the input data element, one or more bits indicating an exponent of the input data element, and one or more bits indicating a mantissa of the input data element, and determining the address of the slope and the intercept of the linear data segment includes determining the address of the slope and the intercept of the linear data segment based on the bit indicating the sign of the input data element and the one or more bits indicating the exponent of the input data element.

Example 20 provides the one or more non-transitory computer-readable media of example 18 or 19, in which the operations further include determine whether the input data element falls into a different range of input data elements of the non-linear activation function, and after determining that the input data element falls into the different range of input data elements, using a predetermined value as a different output data element of the non-linear activation function.

### ADDITIONAL SELECT EXAMPLES

The following paragraphs provide various examples of the embodiments disclosed herein.

Example 1 provides a method for approximating a non-linear activation function in a neural network, the method including identifying an input segment from a range of input data elements of the non-linear activation function, the range of input data elements including a plurality of input segments, the input segment including one or more input data elements in the range of input data elements; determining an intercept and a slope of a linear function based on the input segment; determining whether the input segment is a linear segment of the range by determining whether the non-linear activation function can be approximated by the linear function for the one or more input data elements; and in response to determining that the input segment is the linear segment, storing the intercept and slope in a LUT at an address in the LUT, in which: the address determined based on the one or more input data elements, and the LUT is to be used for computing one or more outputs of the non-linear activation function in the neural network when the one or more input data elements are input into the non-linear activation function.

Example 2 provides the method of example 1, further including determining whether the input segment is a saturation segment based on the one or more input data elements; and in response to determining that the input segment is the saturation segment, storing a value in a saturation table, in which the value is to be used as an output of the non-linear activation function in the neural network when the one or more input data elements are input into the non-linear activation function.

Example 3 provides the method of example 1 or 2, in which determining whether the input segment is the linear segment includes computing an error of approximating the non-linear activation function with the linear function; and determining whether the error is greater than a predetermined threshold.

Example 4 provides the method of example 3, in which the predetermined threshold is a unit of least precision determined based on a spacing between two consecutive floating-point numbers in a floating-point data format.

Example 5 provides the method of example 3 or 4, in which identifying the input segment from the range of input data elements includes selecting an exponent in the range of input data elements as the input segment.

Example 6 provides the method of example 5, further including in response to determining that the error is greater than the predetermined threshold, partitioning the input segment into a plurality of new input segments and determining whether a new input segment is a linear segment.

Example 7 provides the method of example 5 or 6, further including after storing the intercept and slope in the LUT, identifying another input segment from the range of input data elements by incrementing the exponent; and determining whether the another input segment is another linear segment.

Example 8 provides the method of any one of examples 1-7, in which an input data element has a bit indicating a sign of the input data element, one or more bits indicating an exponent of the input data element, and one or more bits indicating a mantissa of the input data element.

Example 9 provides the method of example 8, in which the address is determined based on the bit indicating the sign of the input data element and the one or more bits indicating the exponent of the input data element.

Example 10 provides the method of example 9, in which the address is determined based on at least one most significant bit of the one or more bits indicating the mantissa of the input data element.

Example 11 provides one or more non-transitory computer-readable media storing instructions executable to perform operations for approximating a non-linear activation function in a neural network, the operations including: identifying an input segment from a range of input data elements of the non-linear activation function, the range of input data elements including a plurality of input segments, the input segment including one or more input data elements in the range of input data elements; determining an intercept and a slope of a linear function based on the input segment; determining whether the input segment is a linear segment based on the linear function; and in response to determining that the input segment is the linear segment, storing the intercept and slope in a LUT at an address in the LUT, in which: the address determined based on the one or more input data elements, and the LUT is to be used for computing one or more outputs of the non-linear activation function in the neural network when the one or more input data elements are input into the non-linear activation function.

Example 12 provides the one or more non-transitory computer-readable media of example 11, in which the operations further include determining whether the input segment is a saturation segment based on the one or more input data elements; and in response to determining that the input segment is the saturation segment, storing a value in a saturation table, in which the value is to be used as an output of the non-linear activation function in the neural network when the one or more input data elements are input into the non-linear activation function.

Example 13 provides the one or more non-transitory computer-readable media of example 11 or 12, in which determining whether the input segment is the linear segment includes computing an error of approximating the non-linear activation function with the linear function; and determining whether the error is greater than a predetermined threshold.

Example 14 provides the one or more non-transitory computer-readable media of example 13, in which the predetermined threshold is a unit of least precision determined based on a spacing between two consecutive floating-point numbers in a floating-point data format.

Example 15 provides the one or more non-transitory computer-readable media of example 13 or 14, in which identifying the input segment from the range of input data elements includes selecting an exponent in the range of input data elements as the input segment.

Example 16 provides the one or more non-transitory computer-readable media of example 15, in which the operations further include in response to determining that the error is greater than the predetermined threshold, partitioning the input segment into a plurality of new input segments and determining whether a new input segment is a linear segment.

Example 17 provides the one or more non-transitory computer-readable media of example 15 or 16, in which the operations further include after storing the intercept and slope in the LUT, identifying another input segment from the range of input data elements by incrementing the exponent; and determining whether the another input segment is another linear segment.

Example 18 provides an apparatus, including a computer processor for executing computer program instructions; and a non-transitory computer-readable memory storing computer program instructions executable by the computer processor to perform operations for approximating a non-linear activation function in a neural network, the operations including identifying an input segment from a range of input data elements of the non-linear activation function, the range of input data elements including a plurality of input segments, the input segment including one or more input data elements in the range of input data elements; determining an intercept and a slope of a linear function based on the input segment; determining whether the input segment is a linear segment based on the linear function; and in response to determining that the input segment is the linear segment, storing the intercept and slope in a LUT at an address in the LUT, in which the address determined based on the one or more input data elements, and the LUT is to be used for computing one or more outputs of the non-linear activation function in the neural network when the one or more input data elements are input into the non-linear activation function.

Example 19 provides the apparatus of example 18, in which the operations further include determining whether the input segment is a saturation segment based on the one or more input data elements; and in response to determining that the input segment is the saturation segment, storing a value in a saturation table, in which the value is to be used as an output of the non-linear activation function in the neural network when the one or more input data elements are input into the non-linear activation function.

Example 20 provides the apparatus of example 19, in which determining whether the input segment is the linear segment includes computing an error of approximating the non-linear activation function with the linear function; and determining whether the error is greater than a predetermined threshold.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus for executing a neural network, the apparatus comprising:
a data port to receive an input data element of a function in the neural network;
a look-up table to store one or more parameters of an approximation of the function over a range of input data elements of the function;
an address module to determine, based on the input data element, an address of at least one parameter of the function; and
a compute unit comprising a multiplier and an accumulator, the compute unit to:
receive the one or more parameters of the function from the look-up table based on the address, and
compute an output data element of the function based on the one or more parameters of the function and the input data element.

2. The apparatus of claim 1, wherein the function in the neural network is a non-linear activation function for the range of input data elements, and the approximation of the non-linear activation function for the range of input data elements of the function comprises a linear function.

3. The apparatus of claim 2, wherein the one or more parameters comprise a slope and an intercept of the linear function.

4. The apparatus of claim 1, wherein the input data element has a bit indicating a sign of the input data element, one or more bits indicating an exponent of the input data element, and one or more bits indicating a mantissa of the input data element.

5. The apparatus of claim 4, wherein the compute unit is to compute the output data element based on the one or more parameters and one or more least significant bits of the one or more bits indicating the mantissa of the input data element.

6. The apparatus of claim 4, wherein the address module is to determine the address based on the bit indicating the sign of the input data element and the one or more bits indicating the exponent of the input data element.

7. The apparatus of claim 6, wherein the address module is to determine the address further based on one or more most significant bits of the plurality of bits indicating the mantissa of the input data element.

8. The apparatus of claim 1, further comprising:
a precision adjustment module to reduce a precision of the input data element by changing a first data format of the input data element to a second data format, wherein the precision of the input data element is reduced before the address is determined based on the input data element.

9. The apparatus of claim 8, wherein the output input element is in the first data format.

10. The apparatus of claim 1, further comprising:
a saturation module to:
determine whether the input data element falls into a different range of input data elements of the function, and
after determining that the input data element falls into the different range of input data elements, causing the compute unit to output a predetermined value as a different output data element of the function.

11. A method for executing a neural network, the method comprising:
receiving an input data element of a function in the neural network;
storing, in a look-up table, one or more parameters of an approximation of the function over a range of input data elements of the function;
determining whether the input data element falls into the range of input data elements; and
in response to determining that the input data element falls into the range of input data elements:
determining an address of at least one parameter of the function based on the input data element,
retrieving the one or more parameters of the function from the look-up table based on the address, and
computing an output data element of the function based on the received one or more parameters of the function and the input data element.

12. The method of claim 11, wherein the function in the neural network is a non-linear activation function for the range of input data elements, and the approximation of the non-linear activation function for the range of input data elements of the function comprises a linear function.

13. The method of claim 11, wherein the input data element has a bit indicating a sign of the input data element, one or more bits indicating an exponent of the input data element, and one or more bits indicating a mantissa of the input data element.

14. The method of claim 13, wherein computing the output data element comprises:
computing the output data element based on the one or more parameters and one or more least significant bits of the one or more bits indicating the mantissa of the input data element.

15. The method of claim 13, wherein determining the address comprises:
determining the address based on the bit indicating the sign of the input data element and the one or more bits indicating the exponent of the input data element.

16. The method of claim 11, further comprising:
reducing a precision of the input data element by changing a first data format of the input data element to a second data format,
wherein the precision of the input data element is reduced before the address is determined based on the input data element.

17. The method of claim 11, further comprising:
determine whether the input data element falls into a different range of input data elements of the function, and
after determining that the input data element falls into the different range of input data elements, using a predetermined value as a different output data element of the function.

18. One or more non-transitory computer-readable media storing instructions executable to perform operations for executing a non-linear activation function in a neural network, the operations comprising:
receiving an input data element of a function in the neural network;
storing, in a look-up table, one or more parameters of an approximation of the function over a range of input data elements of the function;
determining whether the input data element falls into the range of input data elements; and
in response to determining that the input data element falls into the range of input data elements:
determining an address of at least one parameter of the function based on the input data element,
retrieving the one or more parameters of the function from the look-up table based on the address, and
computing an output data element of the function based on the received one or more parameters of the function and the input data element.

19. The one or more non-transitory computer-readable media of claim 18, wherein the function in the neural network is a non-linear activation function for the range of input data elements, and the approximation of the non-linear activation function for the range of input data elements of the function comprises a linear function.

20. The one or more non-transitory computer-readable media of claim 18, wherein the operations further comprise:
determine whether the input data element falls into a different range of input data elements of the function, and
after determining that the input data element falls into the different range of input data elements, using a predetermined value as a different output data element of the function.
